(19) United States
(12) Patent Application Publication
(10) Pub. No.: US 2002/0049615 A1
(43) Pub. Date: Apr. 25, 2002

(54) Automated disease management system

(76) Inventor: Janet B. Huber, Conyers, GA (US)

Correspondence Address: HINKLE & O'BRADOVICH, LLC, 395 SCENIC HIGHWAY, LAWERENCEVILLE, GA, 30045, US

(21) Appl. No.: 09/859,912

(22) Filed: May 17, 2001

Related U.S. Application Data
(60) Provisional application No. 60/243,201, filed on Oct. 25, 2000.

(51) Int. Cl. G06F 17/60

(52) U.S. Cl. 705/3

(57) ABSTRACT

Systems and methods for automated disease management are disclosed. A disease management system includes an organizational author that creates disease management pathways having several phases, each pathway designed to manage a particular disease, a case manager that manages patients as they progress along a pathway and a care provider that provides medical or other care for the patient as the patient progresses through the phases of the pathway. The system also includes a system administrator and server that organize that flow and operation of the system.

### BACKGROUND

I. Field of the Invention

The present invention relates generally to the field of networks, and more particularly to systems and methods for automated disease management.

II. Description of the Related Art

The healthcare industry is one of the largest segments of the United States and international economy. It us estimated that approximately one third of the $1 trillion in United States annual healthcare is due to waste and redundancy. Healthcare providers and payers struggle with increasing costs and decreasing revenue, while regulatory agencies, patients and large employer groups demand greater accountability and improved service.

Disease management arose out of the fact that chronic diseases account for more than 70% of healthcare costs. In the United States, direct treatment for asthma diabetes and congestive heart failure alone total over $60 billion annually. Healthcare organizations realize that they can generate substantial savings if they can find a way to improve outcomes and better manage costs.

### SUMMARY

In accordance with the present invention and the contemplated problems which have and continue to exist in this field, the invention features methods and systems for managing diseases based on comprehensive physician-developed knowledge bases. The methods can be powered by secure web-based messaging systems. Messages that are time-triggered regarding patient education and care provider instructions automate the process. Patient and care provider questionnaires can provide documentation of outcomes and goal achievement by discrete data capture. The system is typically inexpensive to implement and easy to learn how to use. In addition, it allows case managers to remotely manage many more patients while providing improved care.

The systems and methods facilitate discrete data capture and variance reporting to determine the best process to use for patient care while providing a process for managing problems outside of the expected pathway sequence, thereby allowing for individualized patient specific care. The systems and methods have user friendly customization features designed to automate management of any disease or severity specific subset of diseases.

The systems operate through questionnaire messages that are sent to and filled out by both patients and care providers to provide documentation of action goal accomplishment and outcomes achievement. Incorrect, “outlier” responses to questionnaires questions and information messaging text lines left unmarked for “read” automatically trigger alert messages to the case manager signifying the need for personalized attention. Alerts are also automatically triggered by breakdowns in the messaging process such as unopened messages, unanswered questionnaires and the like. The systems provide for data to automatically migrate to the documentation spreadsheet where information is then organized for easy access by the care provider.

The systems also provide for a hierarchical, role-based access by the necessary providers. For instance, a system administrator defines billing fields, demographic fields, past history fields, and alerts designations for assigning case managers. The system administrator can also manage a care provider database and create reports based on analysis of data captured. An organizational author who in most instances is a physician representing the organization uses a prewritten knowledge base to build education, instruction and questionnaire messages all according to user-defined standards. The case manager, typically a nurse, assigns patients to pathways, enters patient-specific clinical information, and personally responds to alerts and follows patient progress using the documentation spreadsheet.

In general, in one aspect, the invention features a disease management system, including an organizational author including a computer having a pathway authoring process adapted to be coupled to a network, a case manager including a computer connected to the network, at least one care provider including a computer connected to the network and at least one patient including a computer connected to the network.

In one implementation, the system includes a disease management process having a plurality of pathways, each pathway represented by phases of care.

In another implementation, each of the phases of care further comprises a series of care elements, each care element adapted to be represented by one or more element specifiers and one or more text shortcuts.

In another implementation, the disease management process further includes disease management messages created by the organizational author and adapted to be received by the patient, case manager, and one or more care providers and alerts created by the organizational author and adapted to be received by the case manager.

In another implementation, the system includes documentation spreadsheets.

In still another implementation, the system includes a system administrator including a computer connected to the network and adapted to manage and process data related to the network, a plurality of external databases and a central knowledge base.

In another aspect, the invention features a method of managing disease, including creating a plurality of disease management pathways within a disease management system, assigning a patient to at least one of the pathways, creating correspondence between the patient and one or more healthcare participants, the correspondence relating to managing the patient's disease, dynamically instructing the patient and tracking the patient's progress in the pathway.

In one implementation, dynamically instructing the patient includes providing the patient with healthcare information related to progress through the assigned pathway.

In another implementation, tracking the patient's progress in the pathway includes dynamically analyzing the correspondence.

In another implementation, dynamically analyzing the correspondence includes receiving patient responses relating to the progress in the pathway, detecting the existence of any problems related to the patient's progress in the pathway and addressing any detected problems.

In still another aspect, the invention features a disease management process including creating phases of care for particular diseases, associating care elements within the phases of care, associating element specifiers and text shortcuts for each care element, accessing a knowledge base to cater a program related to the phases of care for the patient to follow, dynamically instructing a patient through the phases of care, enabling correspondence between the patient and healthcare participants, alerting the healthcare participants when there is an alert-situation related to the patient, addressing the alert-situation, keeping documentation related to the patient's progress though the phases of care, optionally modifying the phases of care if changes in the patient's progress occurs and removing the patient from the phases of care if the disease has been successfully managed.

In yet another aspect, the invention features a disease management graphical user interface including a plurality of subject-matter graphical elements that enable a user to view disease management screens, a roster window containing data corresponding to the subject matter of the subject-matter graphical elements and a plurality of navigational graphical elements that enable a user to navigate through a plurality of data screens associated with the interface.

In one implementation, the disease management screens include a documentation spreadsheet related to a patient's progress.

In another implementation, the management screens include a pathway authoring screen, a pathway assignment screen and a clinical summary screen.

In another implementation, the data screens include an active and inactive patient listing and a listing of available pathways.

In still another implementation, the graphical user interface includes an informational bar which displays pathway authoring information such as, but not limited to, the name of the pathway, the name of the pathway, the name of the pathway author, the date of pathway creation, dates of pathway modification, and the position of the author in the pathway authoring algorithm (i.e. position specified by phase of care, care element, messaging templates etc.). The information which is displayed changes dynamically as the author representing the organization moves through the pathway authoring algorithm, so that the author can keep track of his position in the algorithm.

In another aspect, the invention features a method of authoring a disease management process including identifying a plurality of diseases, defining phases of care associated with each the diseases, defining care elements within each of the phases of care, and defining element specifiers and text shortcuts associated with each of the care elements and storing the process in a system.

In one implementation, the method includes authoring messages associated with the phases of care.

In another implementation, the method includes identifying alert situations within each of the phases and creating additional messages associated with the alerts.

In another implementation, the method includes creating a status bar which displays information such as, but not limited to, the name, billing, and demographic data associated with a specific assigned patient and information about the sponsoring organization. The status bar also includes information which tracks the patient's progress through the pathway, which updates dynamically as the patient progresses through the pathway.

One advantage of the invention is that it provides a central low cost and effective outpatient treatment for chronic diseases.

Another advantage is that it provides a flexible format that can be adapted to any disease or severity subset of the disease.

Another advantage is that outlier situations can be managed when goals are not achieved.

Another advantage of the invention is that patient data is dynamically captured, processed and made available to several healthcare participants.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an embodiment of an automated disease management system;

FIG. 2 illustrates an embodiment of a disease management pathway process;

FIGS. 3A-3C illustrate embodiments of navigational screens;

FIG. 4 illustrates a flow chart of an implementation of a pathway naming and defining process;

FIG. 5 illustrates a flow chart of an implementation of a pathway authoring process;

FIG. 6 illustrates a flow chart of an implementation of a pathway assignment process;

FIG. 7 illustrates an embodiment of a patient status bar;

FIG. 8 illustrates an embodiment of a documentation spreadsheet;

FIG. 9 illustrates an embodiment of a messaging detail screen;

FIG. 10 illustrates an embodiment of an alert worksheet screen;

FIG. 11 illustrates an embodiment of an authoring bar;

FIG. 12 illustrates an embodiment of a questionnaire message received by a patient;

FIG. 13 illustrates a schematic which defines the information communicated by the appearance of documentation cells;

FIG. 14A illustrates an embodiment of a navigation screen with roster windows displaying the active patients view;

FIG. 14B illustrates an embodiment of a navigation screen with roster windows displaying the inactive patients view;

FIG. 14C illustrates an embodiment of a navigation screen with roster windows displaying the available pathways view;

FIG. 14D illustrates an embodiment of a navigation screen with roster windows displaying a schematic of the buttons which are available on-screen with each roster window view;

FIG. 15 illustrates an embodiment of a Database navigation screen;

FIG. 16 illustrates an embodiment of a Define data fields screen;

FIG. 17 illustrates an embodiment of a Specialty category screen;

FIG. 18 illustrates an embodiment of a Care providers database list;

FIG. 19 illustrates an embodiment of a Care providers detail screen;

FIG. 20 illustrates an embodiment of a Select messaging templates screen;

FIG. 21 illustrates an embodiment of a Information message composition screen; and

FIG. 22 illustrates an embodiment of a Questionnaire message composition screen.

### DETAILED DESCRIPTION

### Automated Disease Management System

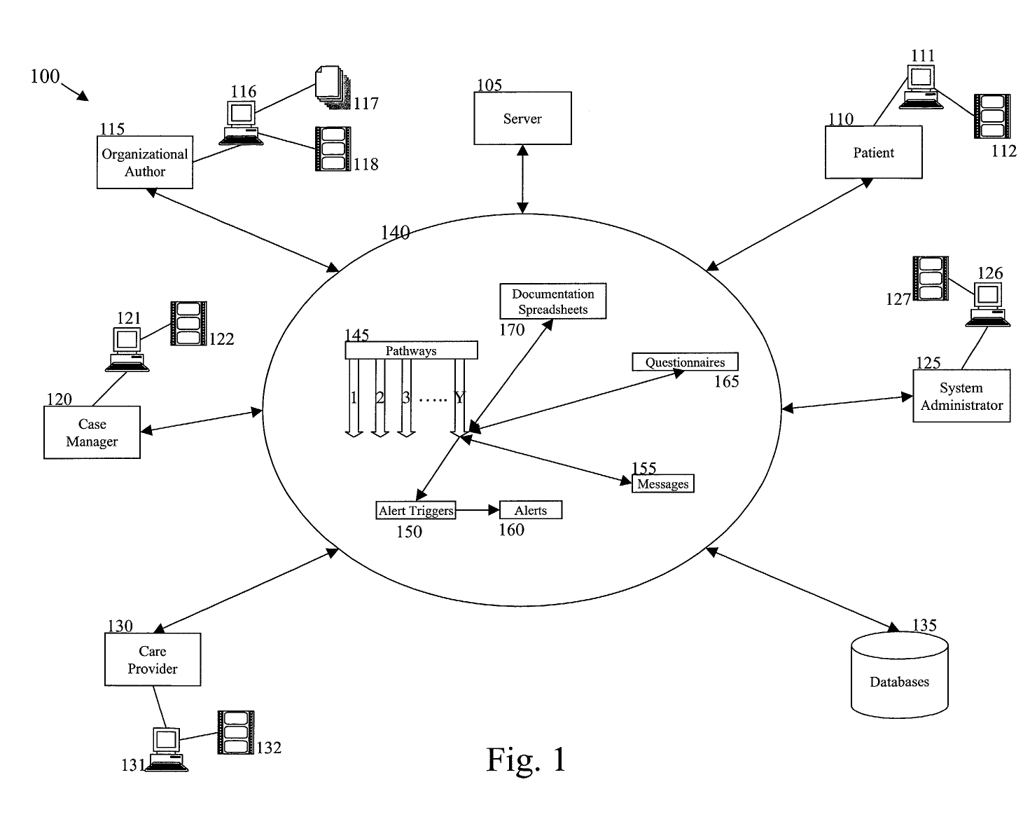

Referring to the drawings wherein like reference numerals designate corresponding parts throughout the several figures, reference is made first to FIG. 1 which illustrates an embodiment of an automated disease management system 100. The system 100 is used to manage the healthcare of a patient 110 on a network 140. A server 105 is the central controller, such as a computer, of the disease management system 100 and a system administrator 125 oversees and manages all of the processes over the network 140. The system administrator 125 can also manage various security and encryption systems on the network 100 to insure protection of patient records and other active information. For example, access to different modules in the system 100, such as for managing cases and authoring new pathways 145 (discussed below) can be based on the role of the participants in the system 100 and be password protected. The system administrator typically includes a computer 126 and a navigational screen 127 on the computer. The navigational screen 127 assists the system administrator in entering and managing data related to the participants on the system 100.

### Time-triggered Messaging

The pathways 145 are used to provide definitive and automated plans for patient 110 care. In an implementation, the pathways 145 utilize web-based messaging. Messages 155 are typically passed among patients, care providers and case managers. The messages 155 are typically information messages, which provide education and instruction, and questionnaires to document goals achievement.

Activity within each pathway is based on time specified triggers 150. For example, a first phase of care within a pathway may be an intensive dietary instruction message to a patient followed by a second phase of care consisting of follow-up questionnaire to measure dietary compliance. As another example, a time trigger 150 launches a message which notifies the care provider responsible for administering a medical treatment that the medical treatment is needed. In this case, a web-based instruction type of information message 155 is used to describe the required medical treatment activity.

### Implementations

The system 100 can be used in a variety of implementations. In one implementation, the system 100 can be used on a local area network (LAN) for a variety of care providers to manage and provide for the care for all the patients registered by the sponsoring organization or hospital in the hospital. In another implementation, the system 100 can be connected to the Internet for availability to an organization of care providers to use the system 100 resources to manage patients for whom the organization is responsible. In another implementation, the system 100 can be used nationally or internationally by institutions or Integrated Delivery Networks (IDNs) to create and utilize treatment protocols so that medical treatments can be shared and developed. In general, the owner of the system can initiate and track actions (such as orders and order sets) through the use of the pathways 145 and can measure the resulting outcomes and goals.

The system 100 also includes documentation spreadsheets 170 that contain all the pertinent data about the patient 110. A detailed description of documentation spreadsheets 170 is discussed below.

The system 100 also can include a time service meter which measures time from the moment that a patient's 110 record is opened until it is closed, as a metric of care provider 130 activity that can be used to document charges for care. Although the time service meter can be accessed by any of the participants, typically the case manager 120 utilizes it.

### Role-base Levels of Access and Navigation Screen

The system 100 includes a variety of participants typically including an organizational author 115, case managers 120, care providers 130 and a system administrator 125. There can be additional participants. These participants operate to achieve goals for a patient 110. Each of the participants has a roles-based level of access to the system 100 in accordance with HIPAA standards. In addition, the system 100 includes mechanisms for tracking and limiting access to patient-specific information in accordance with HIPAA standards.

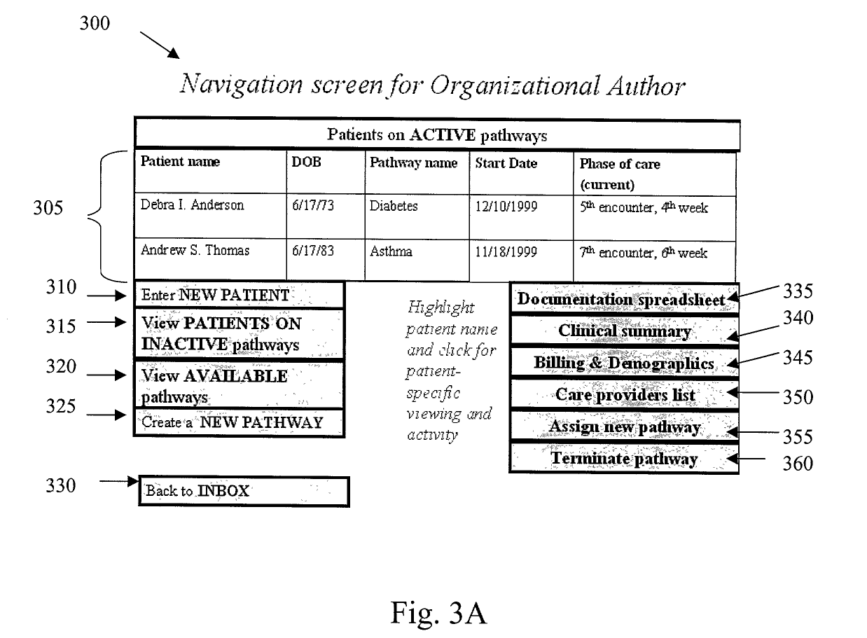

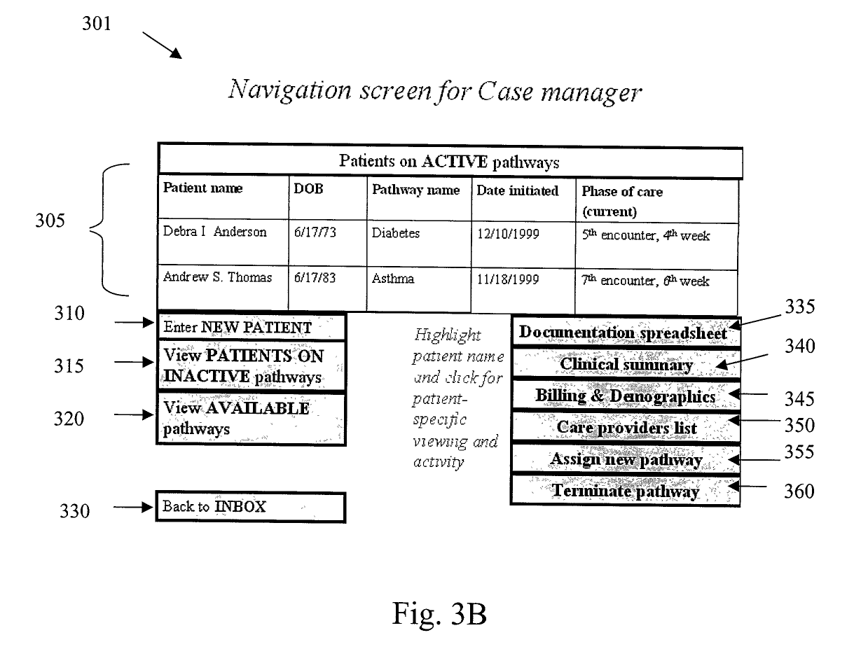

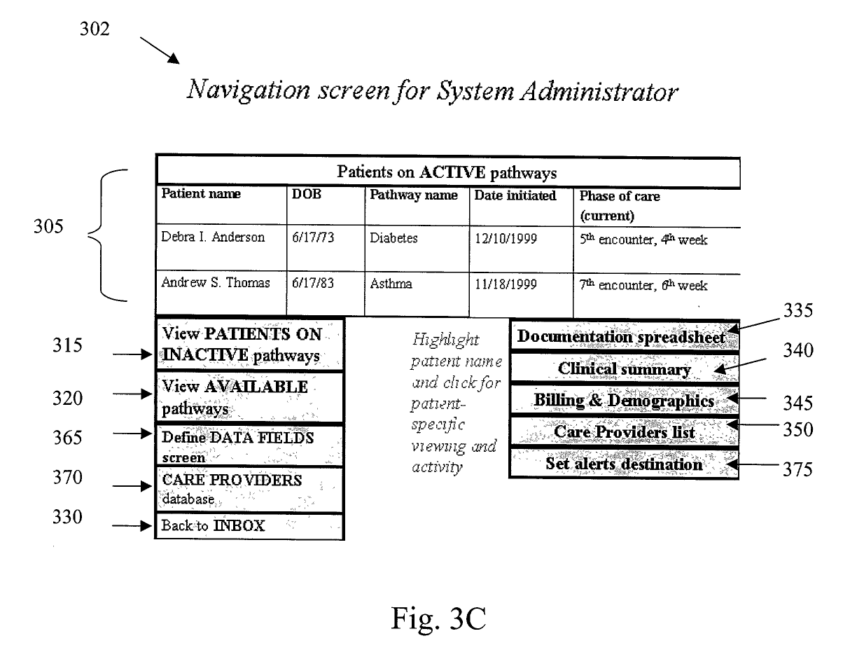

FIG. 3 illustrates an embodiment of a navigational screen 300. The screen 300 is typically the first screen that opens when the disease management process is launched. Permissions and role-specific capabilities are defined by the buttons in this screen 300, which provide access to various parts of the system. Some of the role-specific capabilities are defined for, but not limited to, the following participants: system administrators, organizational authors and case managers. FIG. 3 illustrates an embodiment of the navigation screen for the organizational author (FIG. 3, Part 1), the case manager (FIG. 3, Part 2), and the system administrator (FIG. 3, Part 3). Other care providers, who have been given access to the system by the system administrator, use a navigation screen similar to the case manager's (FIG. 3, Part 2).

In an implementation, if a participant is not authorized to access certain buttons, the buttons are not available on the navigation screen for that participant. Many of the navigation buttons are common to all users of the system. However, buttons which provide access to screens which enable pathway creation/authoring, database management, and patient-specific data entry are available or not available, depending on the role to which the user has been assigned.

The buttons on the left side of the screen provide the user with access to screens for viewing and activities which are not specific for any pre-entered patient. The buttons on the right side of the screen provide the user with access to screens for viewing and activities which are specific for a particular patient. A patient name from the active patient list or inactive patient list in the roster window 305 must be selected by highlighting before these buttons can be activated by clicking.

FIG. 3A is an embodiment of a navigation screen for an organizational author 300. Buttons on the left side of this screen include, but are not limited to, the “Create a new pathway” button, which allows the organizational author to access pathway authoring tools, and the “Enter new patient” button, which allows the user to enter or enroll a new patient into the system. Patient-specific buttons on the right side of the screen, include, but are not limited to, the “Documentation spreadsheet” button 335, the “Clinical summary” button 340, the “Billing and demographics” button 345, the “Care providers list” button 350, the “Assign new pathway” button 355, and the “Terminate pathway” button 360. The use of all these buttons will be explained later.

FIG. 3B is an embodiment of a navigation screen for the case manager 301. This screen includes all the buttons which are available on the navigation screen of the organizational author 300, with the exception that the “Create a new pathway” button is not available. In an implementation, the case manager is not assigned access to pathway authoring tools.

FIG. 3C is an embodiment of a navigation screen for the system administrator 302. This screen includes all the buttons which are available on the navigation screen of the organizational author 300, with the exception that it does not include the “Create a new pathway” button 325 on the left and these patient-specific buttons on the right: “Assign a new pathway” and “Terminate pathway”. In an implementation, the system administrator is not given access to pathway authoring tools or tools for assigning and terminating pathways for individual patients. Unique available buttons on the left side of the screen include, but are not limited to, the “Care providers database” button 370 and the “Define data fields” button 365. Unique available patient-specific buttons on the right side of the screen include, but are not limited to, the “Set alerts destination” button 375. In an implementation, the system administrator assigns the alerts destination (responsible case manager) for each patient enrolled in a pathway, manages the care providers database, and defines the data fields in the system.

The navigation screen 300 includes other buttons for navigation, such as, but not limited to, the “Back to inbox” button 330 which allows all users to escape the system and return to their home screens or email windows.

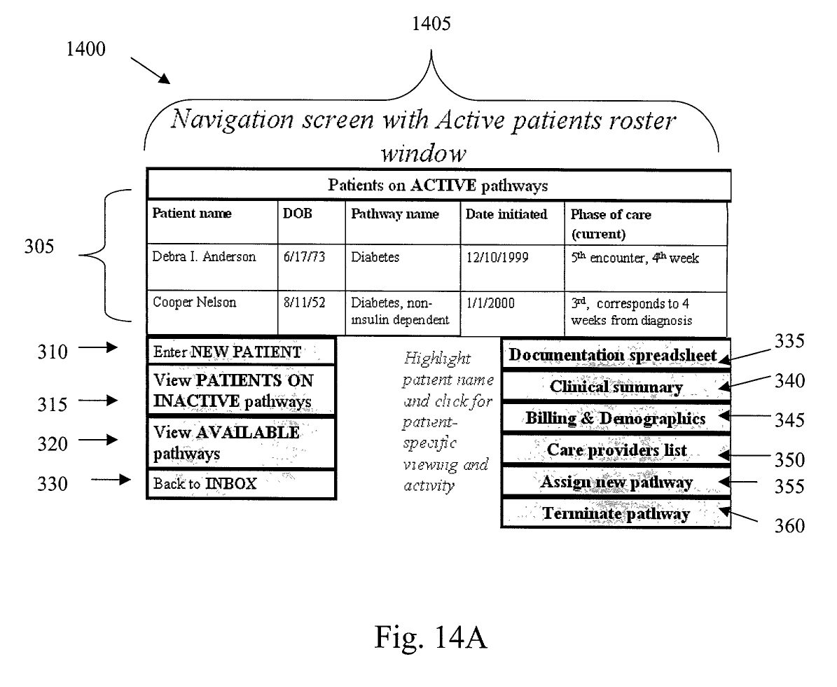

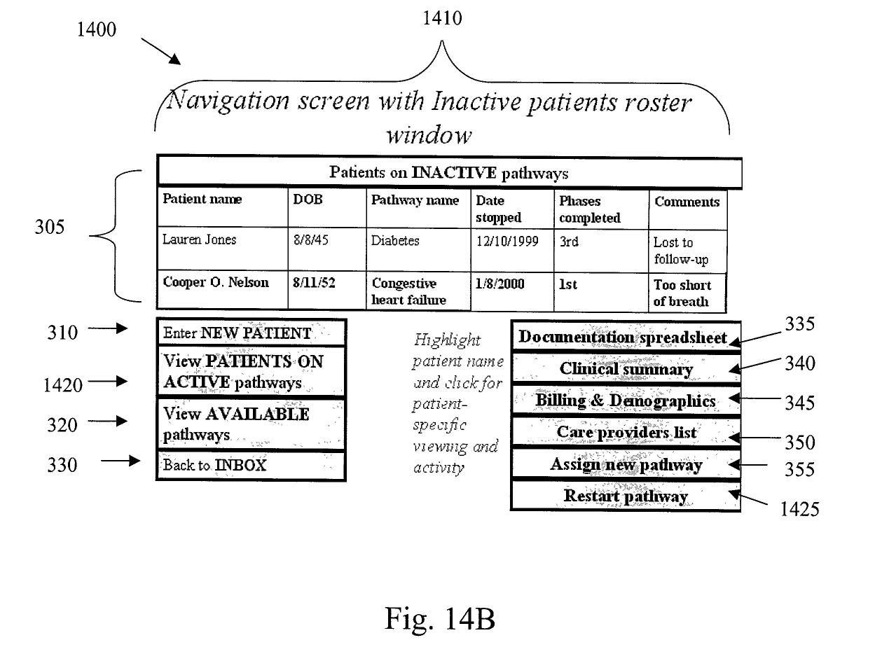

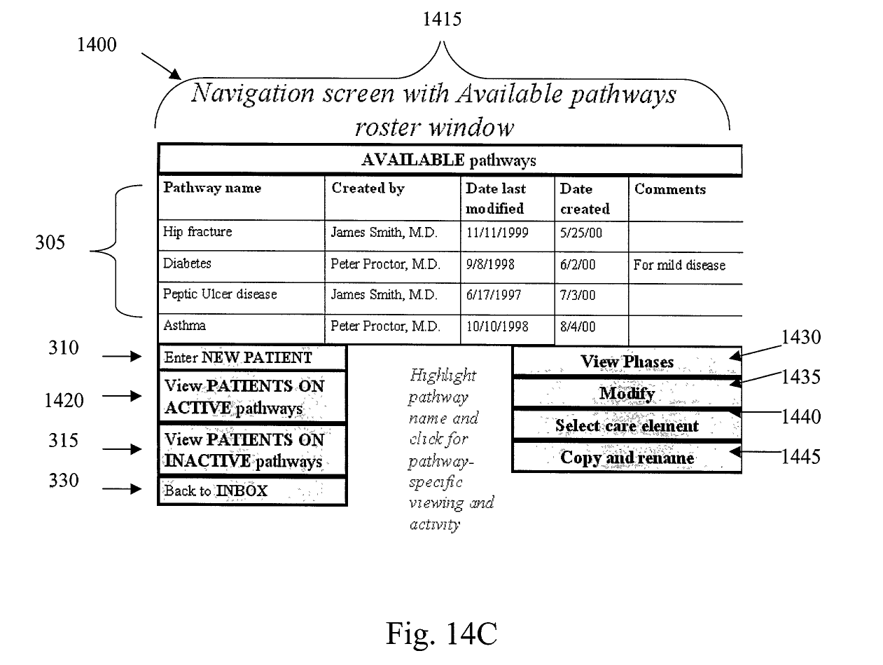

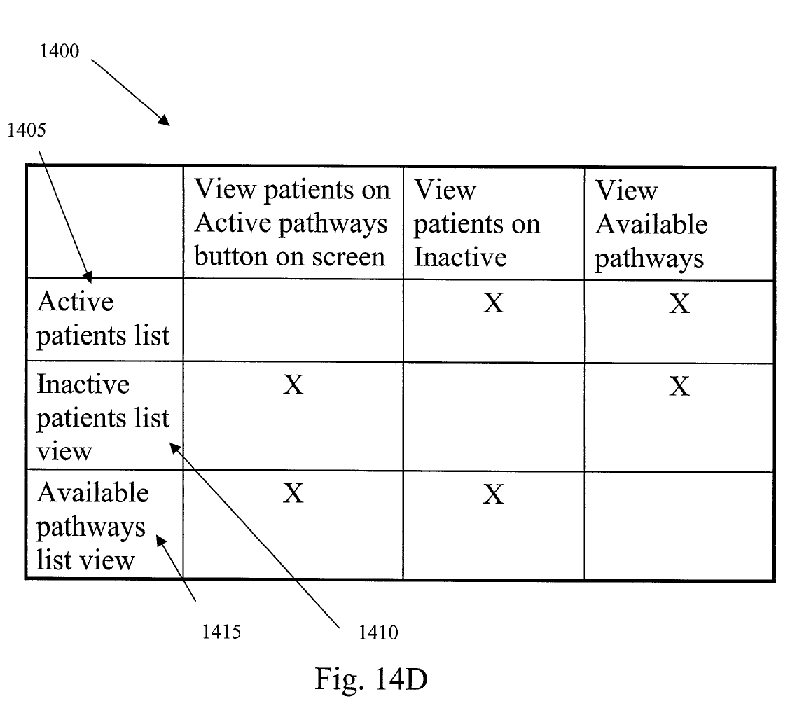

The screen 300 includes a roster window 305, which allows the user to view 3 different lists. Each view in the roster window is associated with some unique buttons which navigate the user to special viewing and activity screens (explained below). Refer to FIG. 14, parts 1, 2, 3 and 4.

FIG. 14A illustrates an embodiment of an “Active patients” roster window 1405 which is the default view. When this view is open, the “View patients on inactive pathways” button 315 and “View available pathways” button 320 are available on-screen. The user can change the view in the roster window 305 to Inactive patients list by clicking the “View patients on inactive pathways” button 315. Alternatively, the use can view the Available pathways list, by clicking the “View available pathways button” 320.

FIG. 14B illustrates an embodiment of an “Inactive patients” roster window 1410. When the Inactive patients list is open in the roster window, the “View available pathways” button 320 and “View active patients” button 1420 are available on-screen.

FIG. 14C illustrates an embodiment of an “Available pathways” roster window 1415. When the Available pathways list is open in the roster window, the “View inactive patients” button 315 and “View active patients” button 1420 are available on-screen.

Basically, the user is able to “toggle” between these views. FIG. 14D is a summary of the buttons which are available with each roster window view.

### Organizational Author

Typically, an organizational author 115 develops a series of pathways 145 that define phases of care for particular medical conditions, pathologies and the like, to be treated. The organizational author 115 is typically provided the tools that he needs to build the pathways 145, view existing pathways 145, view databases of patients and care providers 135 etc. from the server 105. The organizational author 115 is typically a physician or clinical team.

### Case Manager

The main user of the system 100 is typically the case manager 120, often employed by a physician practice or health care plan, taking care of multiple patients with chronic diseases.

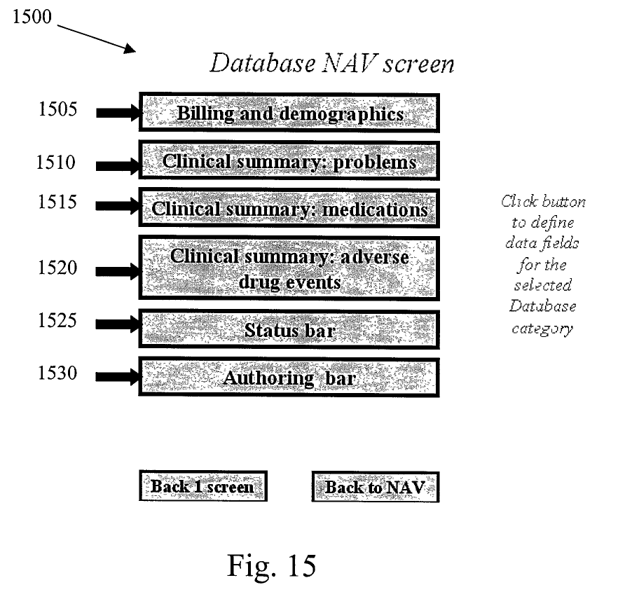

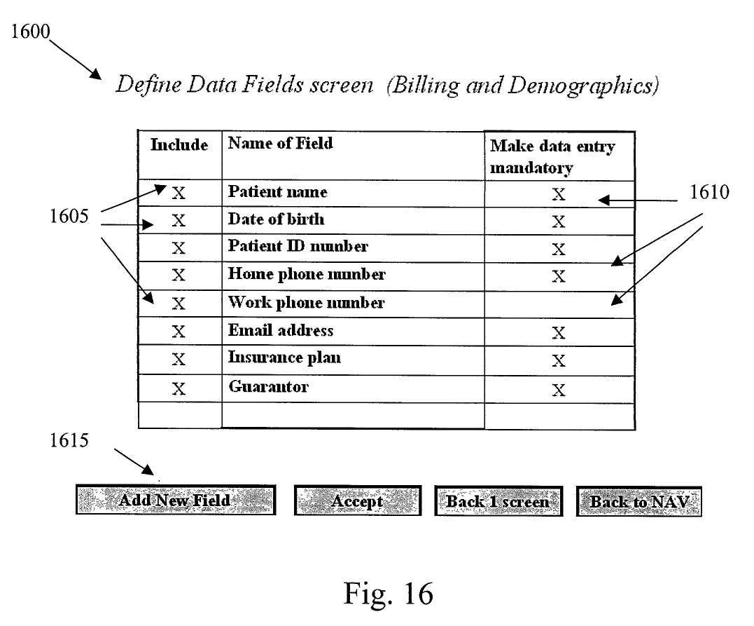

Typically, the case manager 120 uses a computer 121 and is assigned to a variety of patients such as patient 110. The server 105 provides the necessary tools and information that the case manager 120 requires to monitor patient progress and perform activities associated with patient care, including, but not limited to, the computer 121, and a navigation screen 122 with buttons that provide access to a list of active patients 1405 (i.e., patients being actively treated by disease management pathways 145), a list of inactive patients 1410, a list of available pathways 1415, and database information 135 (such as the care provider database). Using the navigation screen 122, the case manager can access screens for viewing and entry of patient-specific demographic, billing, and clinical information (described below using FIGS. 15 and 16) and the documentation spreadsheet 170, which allows the case manger to track patient progress and respond to alerts.

### Patient

As discussed above, patients such as patient 110 are assigned to pathways 145. The patient 110 typically includes a computer 111 and a screen 112 that helps the patient receive data from the participants in the system, answer questionnaire questions, and the like. Much of the patient management is taken care of through the automated features of the system 100, which have already been customized through pathways created by the organizational author. A detailed description of entering a patient into the system, pathway assignment and workflow progress monitoring is discussed below.

### Care Provider

A care provider 130 can be any variety of medical specialists such as, but not limited to, medical doctors, consultants, physician assistants, nurses, dieticians, pharmacists physical therapists and diagnostic centers. The care provider 130 is any professional that can be used in the treatment of a patient. Typically, the care provider 130 includes a computer 131 and a screen 132 that helps the care provider access patient-specific information through the navigation screen 122 and documentation spreadsheet 170, if assigned access by the system administrator to the system, the care provider's navigation screen will typically resemble the navigation screen of the case manager 301.

### System Administrator

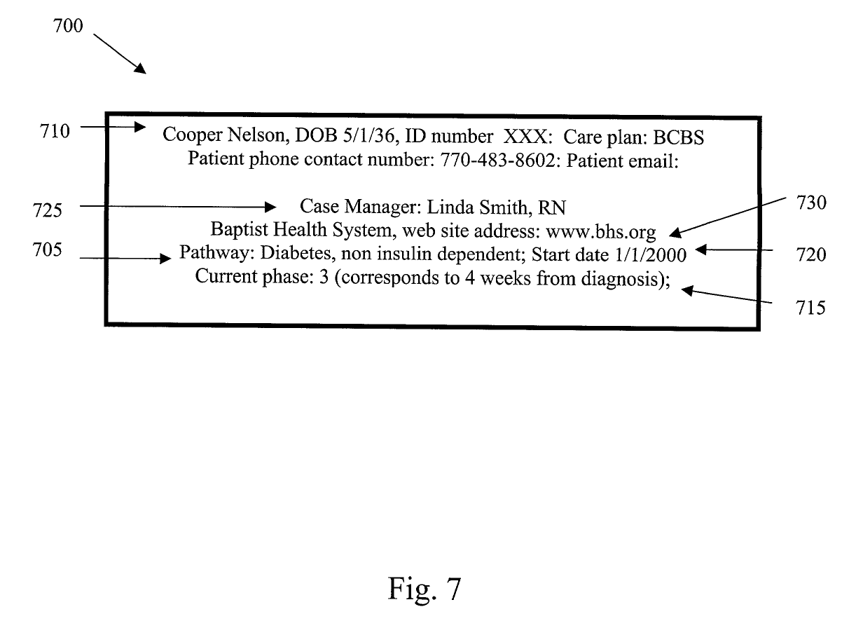

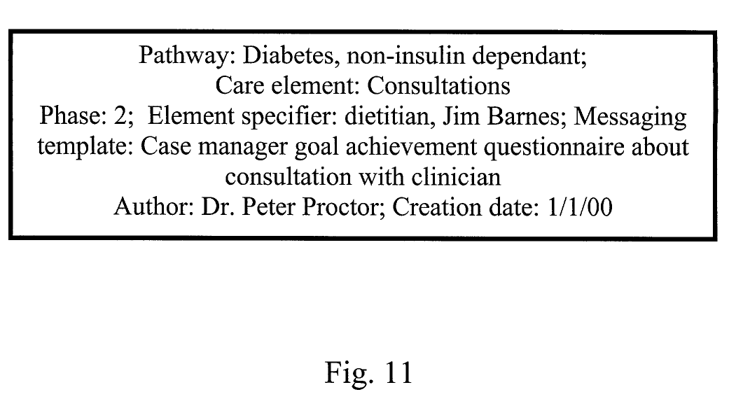

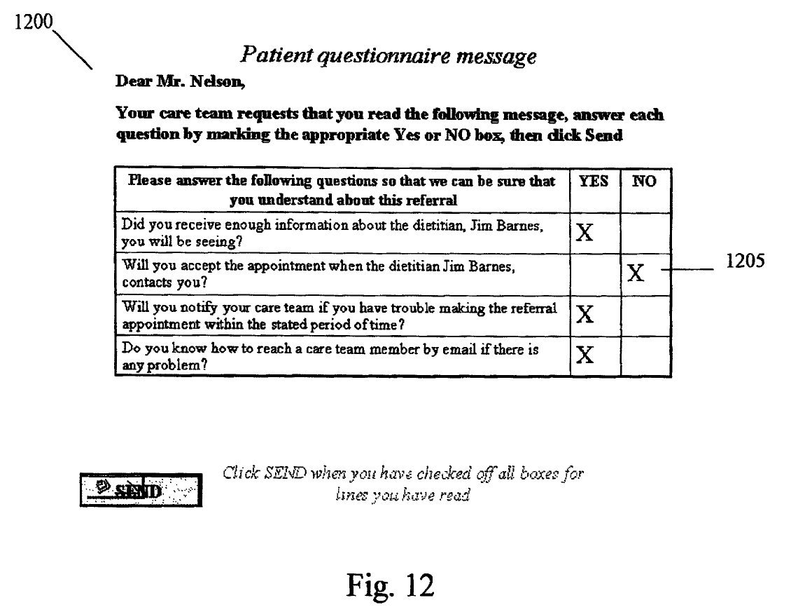

The system administrator's activities involving the system include, but are not limited to, manages the databases of the system. The system administrator enters and maintains the list of care providers associated with the sponsoring organization, and assigns them to pathway activities involving specific patients. The system administrator is responsible for assigning case managers to individual patients so that they will be responsible for them and receive the alert messages 160 regarding them (discussed in further detail below). He defines the data fields for entering and organizing data regarding care providers and patient-specific demographic, billing, and clinical data, including specifications as to whether data entry will be mandatory or optional. Also, he defines what information will be displayed in the status screen FIG. 7 described below and the authoring screen FIG. 11 described below.

### Databases

A variety of databases 135 are connected to the network 140. Only a single database 135 is shown in the figure but it is intended to be representative of any number of databases that can be accessed by the participants in the network 140 depending on roles-based levels of access. The databases 135 can be internal proprietary databases unique to the network 140 and can also be databases external to the network 140.

The external databases 135 can include, but are not limited to, medication lists (e.g. First Data, Micromedex etc.), problem lists (with ICD-9 codes), diagnostic lists (with CPT codes), and patient education materials. Databases external to the network 140 enhance system functionality and facilitate discrete data capture, by reducing the need for free text entry.

Internal proprietary databases 135 can include, but are not limited to, information stored in the pathways, care provider listings, patient-specific information (clinical, billing, demographic, and pathway progression status information), message tracking information (i.e. receiving, opening, responding to messages), and responses to questionnaires 165 from patients 110, case managers 120, and care providers 130 regarding achievement of goals, comprehension of instructions, and compliance with orders, etc.

The databases 135 are managed by the system administrator 125 through the server 105. Database management includes but is not limited to maintaining security measures preventing unauthorized access to information outside roles defined by the system 100, tracking user access to information, storing and organizing patient-specific clinical, demographic and billing information, storing and organizing patient-specific disease management information for both active and inactive patients including pathway status information, storing variances and deviations, compiling reports, supporting the processes which result in generation of time-triggered information messages 155 and questionnaire messages 165, assigning messaging destinations 120 and 130, and performing analyses based on outcomes and variances produced over time by disease management patient populations for clinical bench marking and defining future practices.

### Disease Management Pathways

Since medical treatment for a variety of conditions is standard for most patients, a pathway can be developed and placed on the network so that all care providers can access the pathway and administer treatment in a organized manner helping to guarantee proper treatment and notify the other care providers about each phase of treatment. Pathways traditionally are divided into phases of care. For example, the first phase may be the initiation phase (initiation of treatment), the next phase may be early maintenance, the next phase may be late maintenance, the final phase may be termination, etc. As an example, there can be a pathway for a patient recently diagnosed with hypertension. The initiation or first phase can include diagnostic tests to determine the cause of the hypertension and medications to control the hypertension. Subsequent phases can include other medicine prescriptions, exercise programs and diet regimes.

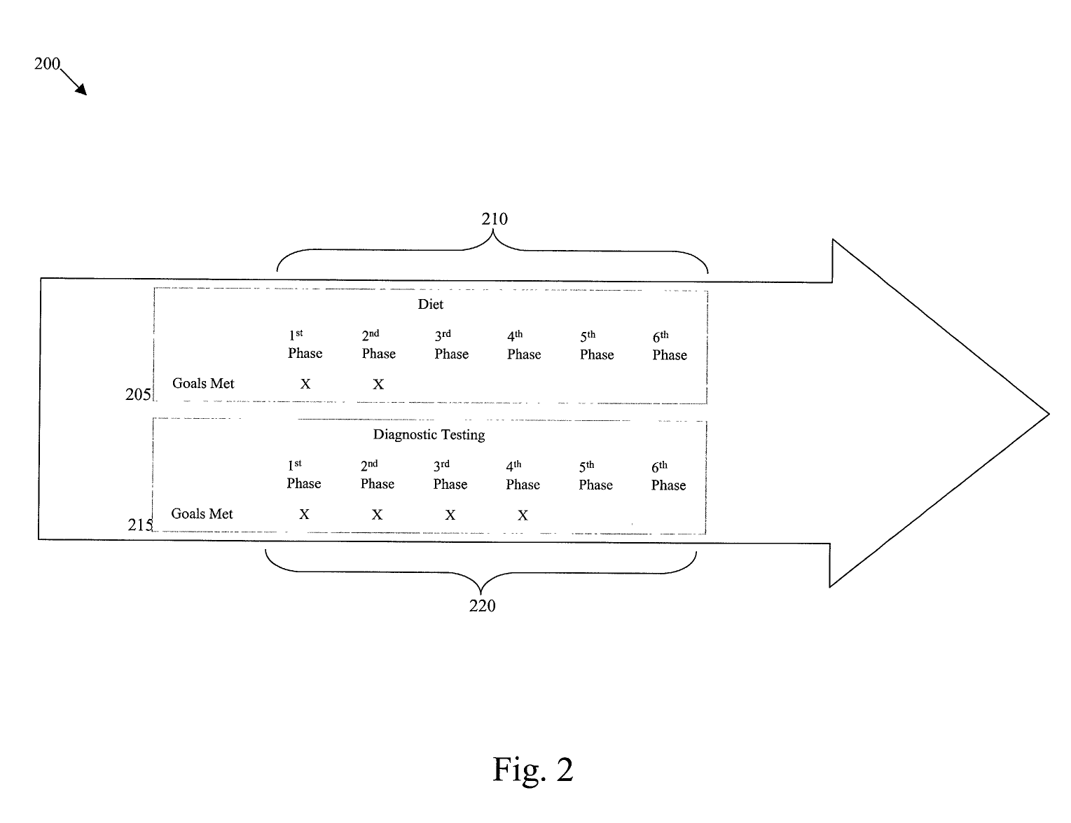

FIG. 2 illustrates an embodiment of a disease management pathway process 200. The process 200 is represented as an arrow for illustrative purposes indicating that pathways such as pathway 200 are progressive in treatment and in time.

There are an infinite number of pathways 145 that can be developed. The figure illustrates pathways 1 through Y. In an implementation, the pathways 145 are typically developed prior to the patient's 110 need for treatment. In another implementation, a pathway can be developed to meet the specific treatment needs of the patient 110 if, for a variety of reasons, the patient may have a special need that deviates from standard treatment. The pathways 145 are therefore also useful to notify all the providers on the network 140 of the deviated treatment.

All disease management pathways are organized around key clinical areas of activity and measurement. In an implementation, these key clinical areas are referred to as care elements. The same care elements may or may not be included in every pathway or every pathway phase. However, all pathway activities and measurements for all diseases consistently involve one, some, or all of these care elements. These are the care elements described by this system: (1) disease awareness (also called education); (2) clinical status (patient-reported symptoms and physical findings such as vital signs); (3) medications (current and non-current); (4) provider-based diagnostic testing (tests done at laboratory and radiology departments); (5) self-testing (tests done at home by the patient and responsible family members); (6) consultations (referrals to home health, physician specialists, dieticians, physical therapists, etc.); (7) diet (diabetic, low sodium, etc.); (8) lifestyle risk factors (smoking, alcohol use, exercise, etc.); (9) vaccination (keeping people at risk up to date); (10) psychosocial (detecting and alleviating social problems and psychological illnesses); and (11) patient satisfaction. These eleven care elements are the building blocks of disease management upon which all pathways are built.

As described above, care elements are the general terms that describe the key clinical areas of activity and measurement which all pathways have in common. In an implementation, the general care elements can be further divided into element specifiers to fit the requirements of specific disease management pathways. For example, diet is a care element that may be common to all pathways. However the care element diet can be divided into specific types of diets that meet the requirements of specific disease management pathways. For example, a diabetic diet, a low sodium diet and a weight reduction diet are all element specifiers, which refer to the care element diet. Therefore, in the three examples previously mentioned, the diabetic diet meets the requirements of the diabetes pathway, the low sodium diet meets the requirements of a congestive heart failure or hypertension pathway, and the weight reduction diet meets the requirements of the obesity pathway. Other examples of care elements and their corresponding elements specifiers are medication (Lasix, Accupril, Insulin, Amaryl), provider-based diagnostic testing (hemoglobin A1C, pulmonary function testing and electrolytes), and consultation (gastroenterologist, Dr. Smith, dietician, commercial laboratory, office-based radiology, home health nurse).

When the organizational author 115 builds messages 155, he selects element specifiers to create disease-specific or patient-specific messages at branch points. The element specifiers are pulled into the messages during the process of creating the messages 155 (discussed further below) and thus become the subject of the messages. Therefore, element specifiers turn general messages into messages that are uniquely appropriate for a particular disease management pathway 145.

The schematic pathway 200 shown in FIG. 2 illustrates two care elements, diet 205 and diagnostic testing 215. It is understood that several additional care elements are typically included in a pathway such as pathway 200. In the schematic example provided by FIG. 2, each of the diet 205 and diagnostic testing 215 care elements have been divided into 6 phases. However, additional phases can be added or deleted depending on the requirements of the pathway.

Many disease management pathways are organized around actions (i.e. order sets) and outcomes (i.e. successful deployment of order sets) for each phase of care. However, in this system, information is organized around the achievement of goals, involving care elements, as specified by phase of care. In an implementation, all order sets, instructions, educational efforts, diagnostic tests, questionnaires regarding compliance and successful treatment, etc. can be described in terms of goal achievement. For example, if dietary instruction has been successful in the first phase, then goals have been achieved for the diet care element in the first phase. If the patient responds to a questionnaire in the second phase that he understands the diet, and intends to follow the diet, then goals have been achieved for the diet care element in the second phase. If the patient responds to a follow-up questionnaire in the fifth phase that he is still following the diet 3 months later, then goals have been achieved for the diet care element in the fifth phase. Alternatively, if the patient does not understand the diet or follow the diet 3 months later, goals have not been achieved for that care element in those phases. Goals for each phase are achieved sequentially as the patient progresses through the pathway.

FIG. 2 presents a schematic of the way information regarding pathway progression is organization by this system. In tabular format, information is organized by phase of care, care element, and goals achievement. Each of the care elements 205 and 215 includes a “goals met” row. This row includes an entry for an “X” indicating whether or not goals have been achieved for the particular care element in the particular phase of care. Here it is shown that the first and second phases of the diet 205 care element have been met and the first through fourth phases of the diagnostic testing 215 care element have been met. The information in this schematic might indicate that the patient and the care providing laboratory have complied with the first through fourth phases of the diagnostic testing 215 care element and that the patient has understood and complied with dietary instructions associated with the first two phases of the diet 205 care element.

In one implementation, a computer connected to the automated disease management system can include a pathway screen that displays pathway information similar to pathway 200. The computer can belong to any of the care providers (including physicians and case managers) in this system. In this way, users can view a particular pathway assigned to a patient and track the patient's progress through the pathway 200, provided they have been assigned access by the system administrator representing the sponsoring organization. A care provider and case manager in particular would like to track the activities and measurements of care elements across the phases of care.

### Knowledge-based, Messaging Templates

The organizational author 115 can use messaging templates to build messages 155 into the system in accordance with pathway requirements. The templates are provided by the system 100 and are derived from an extensive and comprehensive knowledge base that can be accessed from the databases 135. In an implementation, each messaging template is a series of sentence choices that the organizational author uses to build messages for each pathway. The organizational author 115 can choose sentences on the authoring screen by pointing and clicking to make a choice. The templates provide the organizational author 115 with structure, organization and substantial time savings compared to writing free text.

Messaging templates can typically be grouped into such categories as, but not limited to, patient education messages, patient education comprehension questionnaires, patient instruction messages, patient instruction comprehension questionnaires, patient intention to comply with instructions questionnaires, referral instruction messages, referral ability to comply with instructions questionnaires, patient goals achievement questionnaires, referral goals achievement questionnaires, case manager goals achievement questionnaires, and case manager phase anticipation instruction messages.

### Creation of a Pathway: Naming and Defining Phases

In an implementation, the organizational author 115 uses a computer 116 having a graphical user interface. The graphical user interface includes pathway authoring screens 118 and pathway authoring templates 117. In general, the organizational author 115 can use the screens 118 to name the pathways, specify the number of phases of care, and specify the time parameters (e.g., time since diagnosis and time since last encounter) for each phase of care in the pathway. The templates 117, such as messaging templates described above, can include pre-written text choices from a knowledge base for composing questionnaire messages and information (education and instruction) messages to patients, care providers, and case managers to educate, instruct, and document achievement of goals.

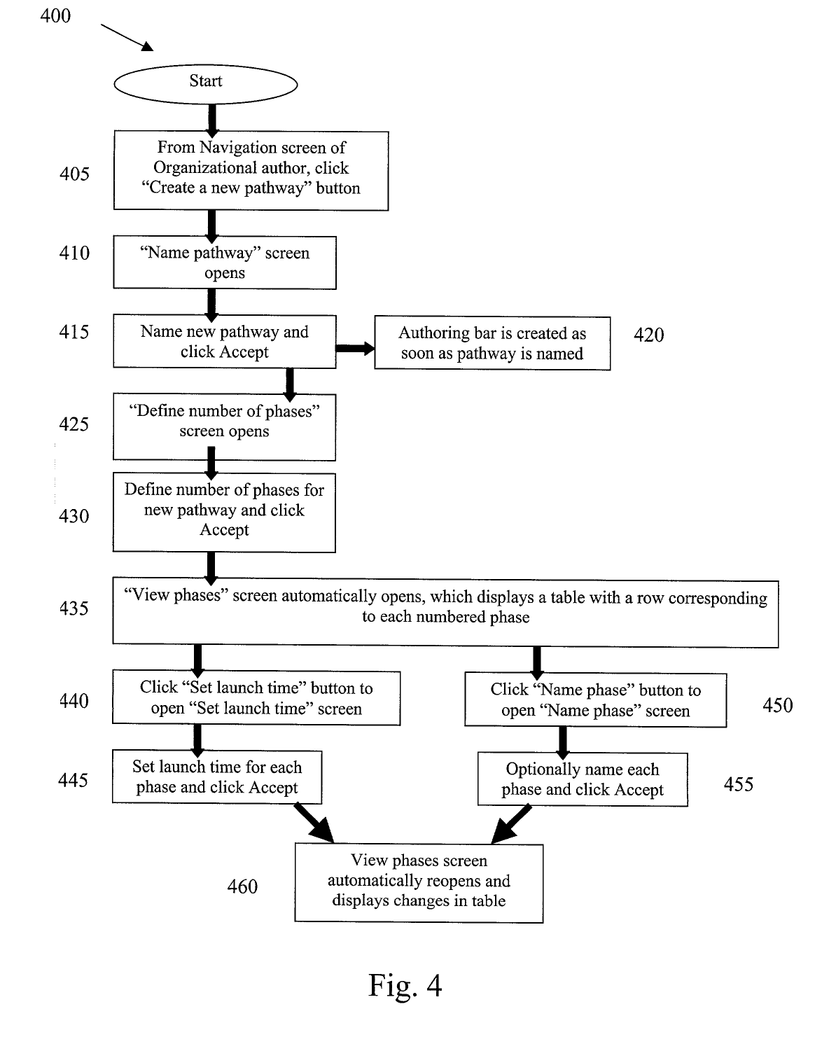

FIG. 4 illustrates a flow chart of an implementation of a pathway naming and defining process 400. The flow chart represents one way in which the organizational author, who can be the Chief Medical Officer of the sponsoring organization, can create pathways. The organizational author who is the user, has access, through the navigation screen, to authoring tools.

From the navigation screen 300, the user first clicks the “Create a new pathway” button 405 on the navigational screen, which opens the “Name pathway” screen 410. A screen (not shown) allows the user to name 415 the pathway, and then click an “Accept” button to apply the name. The “Define number of phases” screen 425 automatically opens so that the user can define the number of phases which will comprise the pathway. The user can then click an “Accept” button to apply the number of phases for that pathway 430. At this time in the process 400, a “View Phases” screen automatically opens 435. This screen is typically a table that displays all phases for the pathway including the names of phases and launch time parameters. This table is dynamically built as the phases of the pathway are further defined. At this point the user must set the launch time for each individual phase by highlighting the numbered phase and clicking the “Set launch time” button to open the “Set launch time” screen 440. The user sets the launch time for each phase 445 and clicks Accept. The user can optionally name the numbered phases, by highlighting the numbered phase and clicking the “Name phase” button to open the “Name phase” screen 455. The “View phases” screen 460 automatically reopens to show the changes in the table (new launch times and new phase names) whenever the user enters data and clicks Accept. This process is typically repeated until each phase is defined by launch time and (optionally) by name. The user then authors 440 messages that accompany the phases (see below).

An example of naming a new pathway, numbering phases and defining the time parameters of each phases can be shown for a diabetes pathway. In a diabetes pathway, six phases might be defined. The first phases might correspond typically to the day of diagnosis, which might be, for example, while the patient was in the hospital. The second phase might correspond to three days after the diagnosis or the first office encounter. The third phase phases might correspond to two weeks after diagnosis or second office encounter. The remaining phases can be defined similarly.

### Authoring Messages for a Pathway

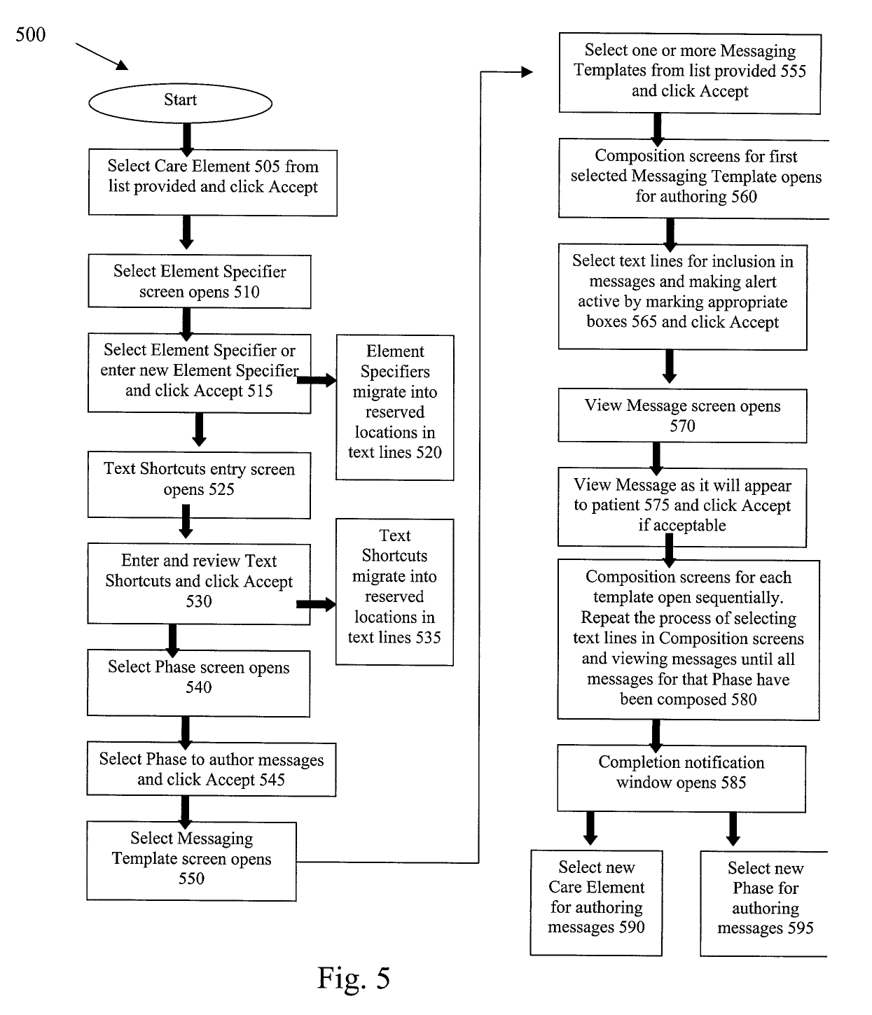

FIG. 5 illustrates a flow chart of an implementation of a pathway authoring process 500. When authoring a pathway, the user first selects 505 a care element (such as care element X, where X represents any of the care elements described above), typically by pointing and clicking a button representing that particular care element on the screen 505. At this point, the “Select Element specifier” screen automatically opens 510. Any pre-entered element specifiers are listed and the user can select one by highlighting the chosen element specifier and clicking the Accept button 515. An external database may provide selection lists for medications (from First Data or Micromedex or the formulary used by the sponsoring organization), problems (with ICD-9 codes), and diagnostic tests (with CPT codes). The user can also add 515 new care elements specifiers using in an entry field on the screen. The selected element specifier is typically the subject of the messages involving the particular care element which will be authored by the user; they migrate into locations reserved for them in the text lines of the messaging templates 520.

Additionally, after the care specifier is selected, the user can review 570 the list of text shortcuts (discussed below) and add to or modify the information in the list where necessary 530. Text shortcuts are unique phrases names, numbers and the like that make a messages unique for a particular disease organization and patient. General text objects reserve locations in the messaging templates. The text shortcuts migrate into the messaging template text locations for the selected care element and element specifier that have been reserved for them by the general text objects 535, creating messages which are unique for the element specifier, the organization, and the patient.

An example of text containing general text objects is, “Please notify <case manager name> at this email address if there is any problem: <case manager email address>.” An example of text after the text shortcuts migrate into the locations reserved for them is “Please notify Linda Smith, RN at this email address if there is any problem: IsmithBHS.com.” Text shortcuts are reviewed, modified and entered by the user after the element specifier has been chosen and before the messaging templates have been selected for use 530.

Shortcuts can be defined on several levels and are customizable by organization. Shortcuts at the organization level are entered through the database by the system administrator and apply to all messages that the particular organization sends. The shortcuts automatically download into the organization section of the text shortcuts table and migrate into reserved text line locations for all messages involving the organization 535.

Shortcuts can also be defined at an element specifier level. Shortcuts defined at this level apply to all messages for a particular element specifier. The information is typically entered manually, directly into the table at the time of the authoring, by the organizational author. The shortcuts associated with a particular element specifier reside in the relevant section of the text shortcuts table and migrate into reserved text line locations for all messages involving that element specifier 535.

Shortcuts can also be defined at the patient level. Shortcuts at this level apply to all messages for a particular patient. The information for these shortcuts is derived from the data which case managers enter about individual patients and resides in the database. The information for these shortcuts automatically downloads into the patient's section of the text shortcuts table after the patient is assigned to a pathway and migrates into reserved text line locations for all messages involving that patient 535.

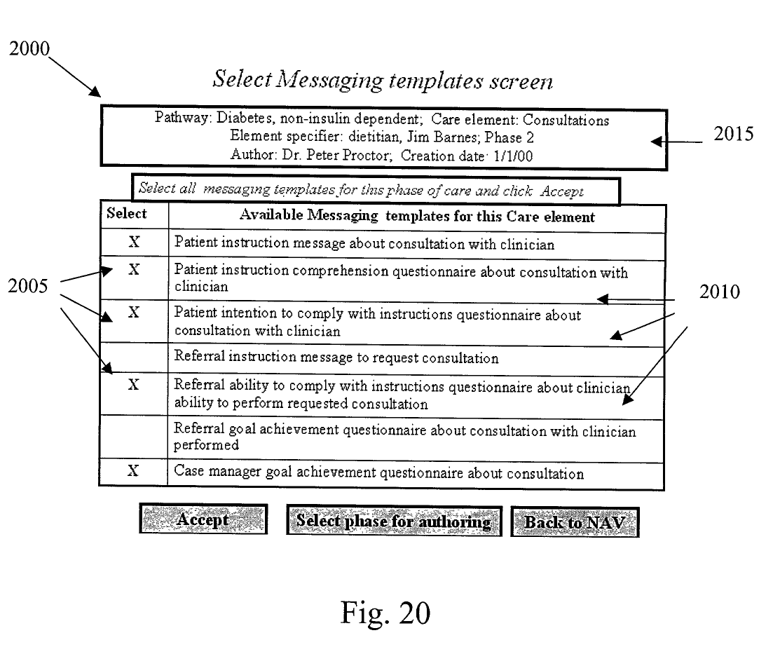

Referring still to FIG. 5, when the author clicks the “Accept” Accept button, a “Select Phase” screen automatically opens 540 where all available phases, which have been defined by the organizational author, are displayed as buttons which can be clicked on to perform activities involving that phase. The user then typically chooses a phase to author messages involving the particular care element and element specifier 545 and clicks Accept. The “Select Messaging Template” screen automatically opens 550 which is linked to the previously selected care element, element specifier, and phase of care. FIG. 20 illustrates an embodiment of a “Select Messaging templates” screen 2000. The authoring bar 2015 (described below) is at the top of the screen. Prewritten templates 2010 from a knowledge database 135 are listed in a table and the user can select which templates he wants to use to author messages by clicking the appropriate box 555 in “Select” field 2005 on the same row as the template 2010. The user can select all, some, or none of the messaging templates that are available to create messages for the selected care element and element specifier, associated with the selected phase of care 555. When the user clicks the Accept button, the system stores the memory of the messaging templates the user has selected to create messages involving the selected care element and the selected element specifier in the selected phase of care. Subsequently, composition screens which correspond to each messaging template sequentially open 560, beginning with the first selected template.

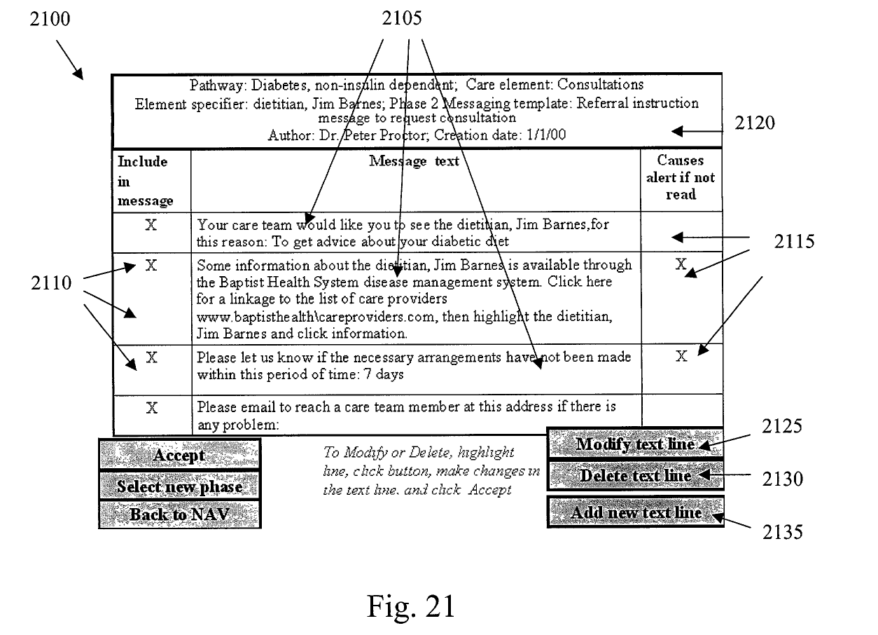

FIG. 21 illustrates an embodiment of an information message composition screen 2100 for a selected messaging template 2010. When the data is formatted, all text lines are listed in tabular format. Element specifiers have migrated 520 and text specifiers have migrated 535 to locations reserved for them to create unique messages. The authoring bar 2120 (described below) is at the top of the screen. Pre-written messaging text lines 2105 from a knowledge database 135 are listed in a table. When the message is sent, each selected text line will include a mark-box that requests the message recipient to mark each line as he has read it. The user selects all text lines from the messaging template for inclusion in the message he is creating 565 by marking fields (cells) 2110 labeled “Include in message” next to the selected text lines 2105. The user can select all, some, or none of the text lines that are available in the information messaging template composition screen 2100 to create messages for the selected care element and element specifier, associated with the selected phase of care 565.

To ensure that information has been communicated effectively to the recipient of the message, each information text line in the delivered message automatically includes a mark-box that requests the message recipient to mark each line as he has read it. The user may or may not choose to make a text line, left unmarked by the recipient of the message, trigger an alert. In other words, the user sets information text lines to be alert active during the authoring process or allows them to remain alert neutral. To make text lines alert active, the user marks the fields (cells) 2115 labeled “Causes alert if not read” next to the selected text lines 2105. If these text lines are left “unmarked” by the recipient of the message, indicating an unread message line, an alert is triggered in the system (more about alerts below).

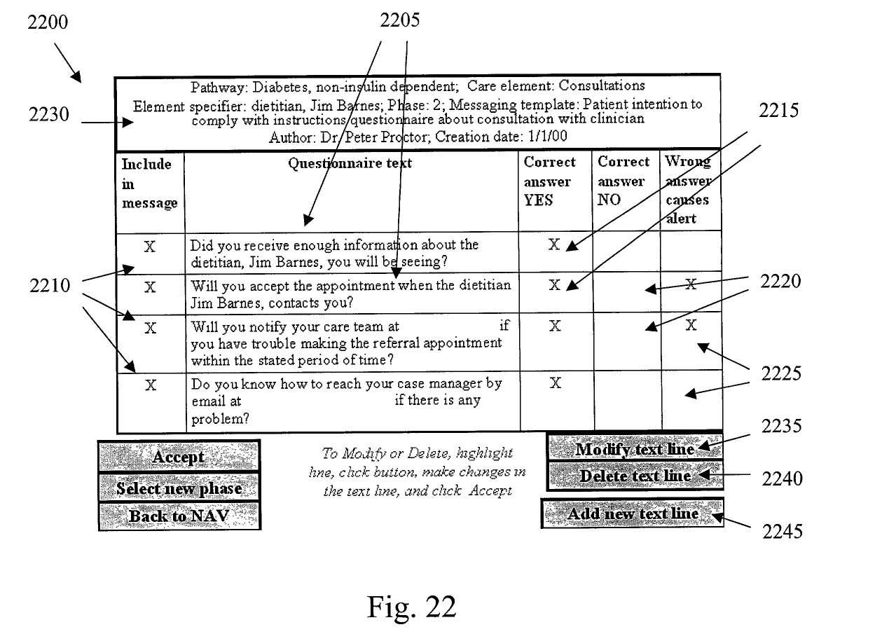

FIG. 22 illustrates an embodiment of questionnaire message composition screen 2200 for a selected messaging template 2010. As described above with regard to information messages, when the data is formatted, all text lines are listed in tabular format. Element specifiers have migrated 520 and text specifiers have migrated 535 to locations reserved for them to create unique messages. As before, the authoring bar 2230 (described below) is at the top of the screen. Prewritten questionnaire text lines 2205 from a knowledge database 135 are listed in a table. When the message is sent, each selected text line will include a mark-box that requests the message recipient to respond to each question by marking yes or no in the mark-box provided. The user selects all text lines from the messaging template for inclusion in the questionnaire message he is creating 565 by marking fields (cells) 2210 labeled “Include in message” next to the selected text lines 2105. The user can select all, some, or none of the questionnaire text lines that are available in the questionnaire messaging template composition screen 2200 to create messages for the selected care element and element specifier, associated with the selected phase of care 565.

As stated above, questionnaire recipients are requested to respond to questions by marking yes or no in the mark-box provided. Depending on the question, the “correct” response may be “yes” or “no”. For example, the “correct” answer to the question, “Will you have a problem getting to the appointment?” is “no”. “Incorrect” answers typically include, but are not limited to, a response by the patient that he cannot comply with a particular instruction, and a response by a care provider (a consultant) that the patient's condition has deteriorated. The questionnaire composition screen includes fields (cells) which allow the user to define the correct, non-outlier answer. If the correct answer is “yes,” the user marks the field (cell) 2215 labeled “Correct answerYES” next to the selected questionnaire text line 2205. If the correct answer is “no,” the user marks the field (cell) 2220 labeled “Correct answer NO” next to the selected questionnaire text line 2205.

The user may or may not choose to make a questionnaire text line, answered with an outlier response, trigger an alert. In other words, the user sets questionnaire text lines to be alert active during the authoring process or allows them to remain alert neutral. To make text lines alert active, the user marks the fields (cells) 2225 labeled “Wrong answer causes alert” next to the selected questionnaire text lines 2205. If the recipient of the message answers a questionnaire line incorrectly, creating an outlier response, an alert is triggered in the system (more about alerts below).

After the user has authored each message, the user clicks the Accept button and the “View message” screen automatically opens 575. The user can then review the message that has just been authored as it will appear when delivered to the patient and then accept it, if it is acceptable 575.

The user can return to the composition screen to make any modifications to the information or questionnaire messages, if necessary. Referring to FIG. 21, the user can highlight a text line 2105 or 2205 in the table and click the “Modify text line” button 2125 or 2235 to make changes to the line. The user can highlight a text line in the table and click the “Delete text line” button 2130 or 2240 to remove the text line from the table. Alternatively, the user can remove a previously selected text line from the message he has just authored by “unmarking” the “Include in message” field (cell) 2110 or 2210. Furthermore, the user has the option of creating entirely new text lines by clicking the “Add new text line” button 2135 or 2245 and opening a screen (not shown) for creating new text lines.

The user can typically author multiple messages for each phase of care. After the user authors the first messages, views it as it will look when it is delivered to the patient, and clicks Accept, the next composition screen for the next selected messaging template opens automatically 585. The user repeats the process of selecting text lines to create information and questionnaire messages. As earlier, the user makes modifications where needed, then accepts the modifications and reviews the modified message in the “View message” screen.

This process typically continues with each template chosen in the select messaging templates for that phase of care: compose message, view message, compose messages, view message etc. 580.

When the last messages for the selected care element, selected element specifier and selected text shortcuts for the selected phase of care have been composed and viewed, then a completion notification window 585 opens to notify the user that the messaging for this phase is complete. The user can then open the “Select care element” screen to continue authoring messages, but using a new care element 590. Alternatively, the use can open the “Select Phase” screen to continue authoring using the same care element, same element specifier, and same text shortcuts, but for a new phase of care 595.

The user has the option of postponing a launch time for three types of messages. Typically, all messages launch at the same time when a new phase begins except for these three types: goal achievement questionnaires (that document achievement of goals-typically launched in the middle of the current phase); phase anticipation information messages (to prepare case managers and patients for up-coming events linked to the next phase-typically launched at the end of a previous phase); and follow-up questionnaires (to stimulate the case manager to follow-up on results of tests or responses to treatment—typically launched near or at the end of the current phase).

The view messages screen for these types of messages include a button for modifying the launch time (not shown). This button opens screens with unique fields for setting special launch times for these three message types e. g. case manager phase anticipation messages, goal achievement questionnaires, and follow up questionnaires. An Accept button can be clicked to finalize these changes in launch time.

In another implementation, the screen computer 116 can include an authoring bar. FIG. 11 illustrates the embodiment of an authoring bar which is an informational window that displays pathway authoring information such as, but not limited to, the name of the pathway, the name of the pathway author, the date of pathway creation, dates of pathway modification, and the position of the author in the pathway authoring algorithm (i.e. position specified by phase of care, care element, messaging templates etc.). The information which is displayed changes dynamically as the author moves through the pathway authoring algorithm, so that the author can keep track of his position in the algorithm. The contents of the authoring bar are defined by the system administrator.

### Modifying Pathways

To modify a pathway, the user clicks the “View available pathways” button 320 on the navigational screen to change the view in the roster window from the default view (“Patients on Active pathways”) to the “Available pathways” view. FIG. 14 illustrates the embodiment of a navigation screen 1400 with the “Available pathways” view in the roster window 1415. The user then highlights the name of the pathway he wishes to modify and clicks the “Modify” button 1435 that automatically opens the “Name Pathway” screen (not shown). The user can then scroll through several screens that do not need modification until the user locates the screen that he wishes to modify. Following on-screen instructions, the user highlights the field he wishes to modify, makes the desired changes, and clicks the Accept button. The user can repeat this process for several screens until all desired modifications have been made. To view and modify messaging text lines, the user can more directly access message composition screens by clicking the “Select Care Element” button 1440 in the “Available Pathways” view of the roster window 1415. Then he selects the care element, selects the element specifier, and makes changes in the text shortcuts table. Alternatively, he scrolls through several screens, selecting the phase and messaging template which contain the text line or text lines he wishes to modify. Then, following on-screen instructions, the user highlights the text line, makes the desired changes, and clicks the Accept button (as described above). When finished with the modification process, the user clicks the “Back to Nav” button to return to the main navigation screen 300 and, from there, exits the system by clicking the “Back to Inbox” button 330.

The user can reuse or “recycle” existent pathways to quickly make new pathways that largely resemble the parent pathway. This allows the user to create multiple new pathways from one basic disease management pathway, that vary according to disease severity or treatment requirements. For example, the user can start with a basic diabetes pathway which is listed in the “Available pathways” roster window 1415 and click the “Copy and rename” button 1445 to open the “Name pathway” screen. A warning window notifies the user that the established (pre-written) pathway has been copied and all subsequent activity will apply to a new pathway (which still contains all the components of the older, established pathway.) Then the user renames the pathway 410 according to disease severity (e.g. mild diabetes), treatment requirements (e.g. insulin-dependent diabetes), or the needs of a specific patient (e.g. John Smith's diabetes pathway), and scrolls through the screens making changes wherever appropriate. For the example of the Insulin-dependent diabetes pathway, the user might add a new element specifier under the Medication care element (insulin) and write new messages to patients, care providers, and case managers which pertain to this new element specifier. If John Smith needs to have unique dosing schedule for insulin, the new John Smith's Diabetes pathway will have all the components of the old established pathway from which it was derived, except that its insulin dosing messages will be unique for John Smith.

In an implementation, the system administrator 125 determines the accessibility of the pathways 145 on the network 140 which have been authored by the organizational author 115. In general, the messages created by the user are stored in the server until a patient has been assigned to a pathway, typically by the case manager.

### Entering a New Patient into the System

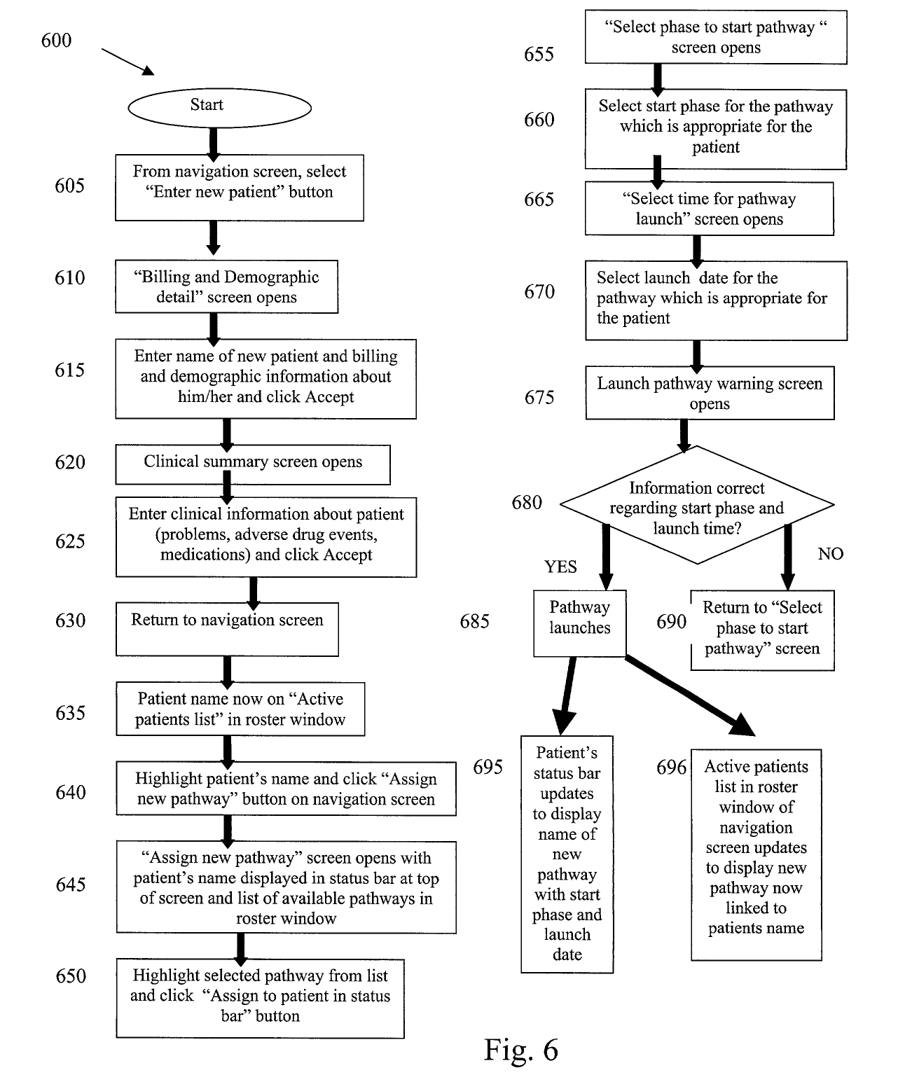

FIG. 6 illustrates a flow chart of an implementation of a process for entering a new patient into the system and of assigning a new pathway to the patient 600. To enter a new patient into the system, the user (who is typically the case manager) clicks on 605 the “Enter New Patient” button 310 on the navigational screen, which opens a screen for entry of billing and demographic data regarding the new patient, including the patient's name 610. The fields for the information have typically been set by the system administrator, who also determines which fields are mandatory charting. If a field is mandatory, the screen which displays it will not close until data has been entered into the field. The user enters the billing and demographic information about the new patient 615 and clicks the Accept button. The clinical summary screen then opens automatically 620. The clinical summary information section is divided into three categories of data entry, so that the user can enter 625 clinical information about problems, adverse drug events, medications and the like, which is specific for a given patient. The clinical summary screen is a navigation screen, with three buttons that correspond to the three categories of data entry. A unique screen for each clinical summary category, which allows the user to enter data and view organized information, opens when the corresponding button is selected by point and click. For problems, the user typically enters information defining medical problems, both active and inactive, including the date of onset and severity. An external database which lists medical problems (with corresponding ICD-9 codes) for point and click selection can be used to facilitate this process. For adverse drug events, the user typically enters the name of the responsible drug, the date of onset, the severity and the type of reaction. For medications, the user enters the names of medications, current and inactive, with dosage strength, start date and the like. An external database which lists commonly used medications for point and click selection can be used to facilitate this process. The patient-specific data in these fields can be modified and up-dated as needed throughout the patient's progression through the pathway phases.

Once this information has been entered, the user typically returns 630 to the navigational screen. The patient's name has automatically been added to 635 the “Active patients” list 1405 in the system, as viewed in the roster window. Typically at this point, the pathway name field (cell) which is associated with the new patient's name in the table (on the same line) is blank, because a pathway has not yet been assigned to the patient.

In an implementation, a status bar 700 is automatically created when a new patient is entered into the system. The status bar 700 is used for viewing patient-specific information and tracking patient progress through the system and is typically located at the top of every patient-specific screen. The system administrator determines what information will be displayed in the status bars for the organization he represents.

FIG. 7 illustrates an embodiment of a patient status bar 700. The status bar 700 displays a title line which is also the patient information line 710. This line typically includes, but is not limited to, the patient name, date of birth and identification number. The patient information line can also include other billing and demographic information, such as but not limited to, address, telephone number, fax number and email address and the name of the case manager assigned to the patient by the system administrator 725. The status bar also displays pathway information in a pathway line. This line includes the pathway name 705 and pathway status information 720, such as, but not limited to, the start date for the pathway 720, the patient position in the pathway progression as defined by current phase 715 the time parameters that correspond to the current phase (corresponds to four weeks since diagnosis) and information about outlier situations (i.e., overall status: 3rd phase of care, Outlier status: second phase of care for diagnostic testing element). The status bar 700 also displays an organization line 730 which can include, but is not limited to, the name of the sponsoring or funding organization and organizational contact information, such as phone numbers, web site addresses, and email addresses, as defined by the system administrator.

### Assigning a Pathway to a Patient

Continue to refer to FIG. 6. To assign a pathway to a the patient, the user can select the patient's name from the “Active patients” list 1405 by highlighting the name and clicking 640 the “Assign New Pathway” button 355 on the navigational screen. The “Assign new Pathway” screen opens 645. The main features of this screen are the roster window, which displays the list of available pathways, and the patient's status bar at the top of the screen. The user selects a pathway by highlighting the pathway name, then clicking the “Assign To Patient In Status Bar” button 650. This action automatically links the selected pathway to the patient name specified in the status bar. The status bar also updates to display the name of the newly assigned pathway.

The “Select phase to start pathway” screen automatically opens 655 after the pathway has been assigned. This screen displays a list of buttons corresponding to the phases of the pathway (e.g. phase 1, phase 2, etc.). In many implementations, it may be appropriate for the patient to start the pathway in a phase other than the initial (first) phase. Therefore the user selects the start phase 660 which is clinically appropriate for the particular patient, by clicking the corresponding button; the status bar updates to reflect this change (see 720 in FIG. 7 below). Next, the “Set Time for pathway launch” screen automatically opens 665 so that the user can define the time parameters for launching the pathway for the particular patient. Typically the default start date is the current date. However, the user can choose from a variety of future dates, typically within the next twenty days, from a drop down selection window present on the screen. The user selects the appropriate date and clicks “Accept” 670. Once the date is selected, a “Launch pathway warning” window opens 675 over the “Set Time For Launch” screen. The warning window includes the name of the new pathway, the selected start phase and the selected start date. If the information in the warning window is not correct, the user can return to the “Select phase to start pathway” screen by clicking a button in the warning window 690. If all of the information is correct 680 670, the user can click the “Execute” button to launch the pathway 685. The main navigation screen automatically reopens to display the “Active patients” list in the roster window. To reflect the recent activity, the list updates 695 to display, on the same line as the patient name, the name of the new pathway, the start date, and the pathway progression status (i.e. the current phase), all linked to the new patient. In an implementation, the contents of the status bar 700 is automatically updated when a pathway is assigned 695 to include the name of the new pathway, the start date and the pathway progression status (i.e. the current phase). Thereafter, the information in the status bar dynamically updates with activity as the patient progresses through the system.

Typically, when the user assigns the patient to a pathway, the server receives a message that the patient has been assigned and launches the pathway. The server downloads a new documentation spreadsheet into the patient's file (discussed below) which contains the newly assigned pathway, now linked to the patient's name in the system.

### Documentation Spreadsheets

As discussed above, as the patient progresses through the pathway, all messaging information is captured by the system and saved as discrete data. It is stored in tabular format, organized by care element, element specifier and phase of care and progress is documented in terms of goals achievement. This collection of patient-specific information is called the document spreadsheet.

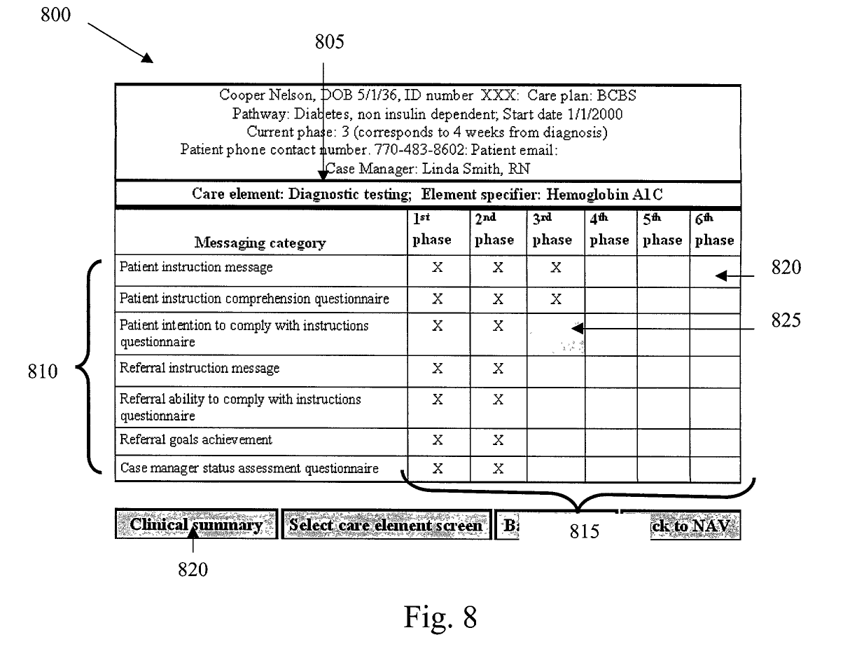

FIG. 8 illustrates an embodiment of a documentation spreadsheet 800. The documentation spreadsheet is similar in format to the embodiment of a pathway 200 as shown in FIG. 2. The spreadsheet format allows for itemized checklist viewing across phases of care delivery. The spreadsheet combines a visual and textual checklist. In FIG. 2, the spreadsheet 800 for the provider-based diagnostic care element 805 is shown. The columns 815 are the phases of care and the rows 810 are the messaging categories. Generally, all of the messages that can be authored fall into one of the broad categories in the rows.

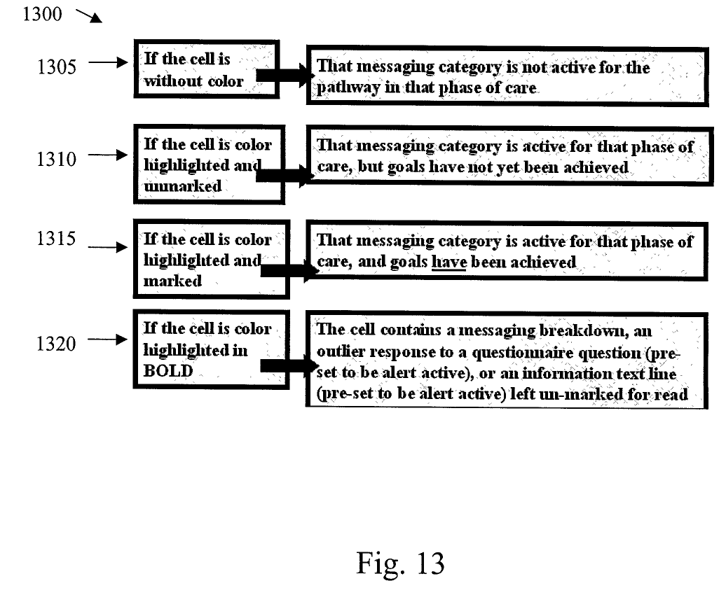

A documentation cell 820 is defined by the phase of care and messaging category it represents. The documentation cells contain information about the messaging process and information regarding goal achievement. Refer to FIG. 13 which is a reference schematic that defines the information communicated by cell appearance. I n an implementation, the individual cells can be color highlighted 1310 indicating that there will be pathway activity and future goal achievement requirements associated with the cells. The absence of color highlighting in a cell 1305 means that there will be no pathway activity or future goal achievement for the phase of care and messaging category which the cell represents. In this way, the user who is viewing the documentation spreadsheet can anticipate, at a glance, where future activity and goal achievement requirements will be, by phase of care and messaging category, for the pathway assigned to the patient.

As message tracking and questionnaire response data is accumulated by the system, it affects the spreadsheet 800 in a variety of ways as summarized in FIG. 13. In one implementation, if goals are achieved, the documentation cells are marked with an “X” 1315, and if goals are not achieved then the cells are not marked 1310. Furthermore, if there is a messaging breakdown (e.g., a message may not have been opened or may lack a response) or an outlier response to questionnaire question, or an information text line, set to be alert-active which has been left unmarked for “read” by the recipient, the documentation cell becomes highlighted in a bold color 1320, indicating that it contains an alert which has been triggered by an non-routine, outlier event.

In summary, if a documentation cell has no color, the messaging category is not active for the pathway in that phase of care 1305. If the cell is color highlighted and unmarked, the messaging category is active for that phase of care, but the goals have not yet been achieved 1310. If the cell is color highlighted and marked, then the messaging category is active for that phase of care and the goals have been achieved 1315. If the cell is color highlighted in bold, the cell contains a messaging breakdown, an outlier response to a questionnaire question (preset to be alert active), or an information text line (preset to be alert active) left unmarked for read 1320.

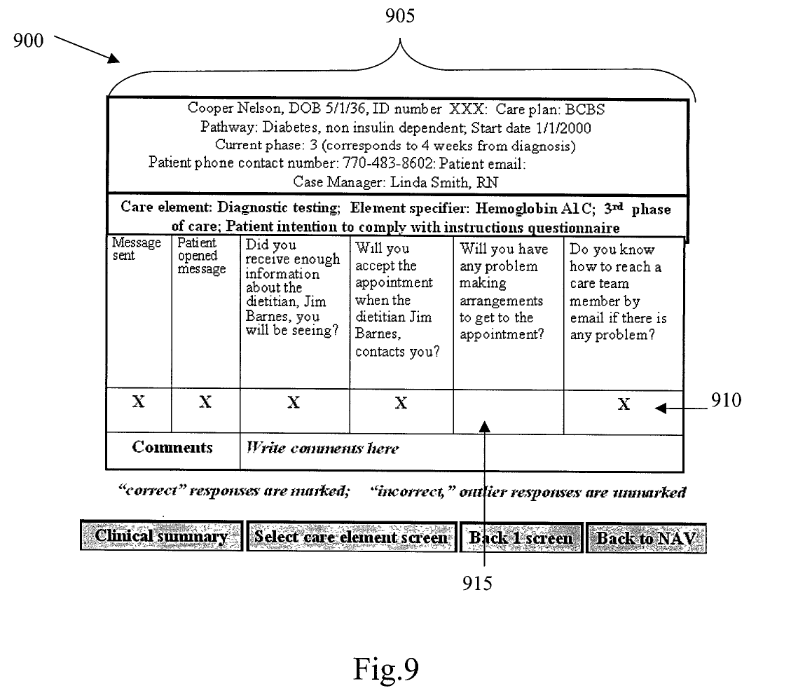

Each individual documentation cell 820 has a layer of information behind it which can be accessed by double-clicking on the cell. A user can click on a cell in order to view the messaging detail screen FIG. 9, which resides behind it.

FIG. 9 illustrates an embodiment of a messaging detail screen 900. The detail screen 900 generally provides message tracking information, the responses to questionnaire questions, and the read/non-read status of information text lines, for a particular element specifier. The column headings 905 display parameters that track messaging efficacy, the actual questions from the questionnaires and the actual text lines from the information messages. Many of the question lines and information text lines contain an element specifier in the text (i.e., dietitian), which has been “pulled in” to the lines during the authoring process. In implementation, the screens are read only, but contain a field for comments by the user, such as the case manager.

As described above, the user can double click on a documentation cell 820 to view the messaging details associated with the documentation cell. Referring to FIG. 8 again, this second layer of information is especially helpful if the documentation cell 820 is alert-activated 825 (boldly highlighted) because more detailed information about the alert resides behind it. In the example above, the documentation cell is boldly highlighted, indicating an alert situation associated with the messaging category and phase of care which the documentation cell represents 825. That documentation cell can be referred to as alert-activated 825. The user double-clicks on the documentation cell to open the messaging detail screen FIG. 9 which resides behind it. In this example, the user can comprehend at a glance that the patient has received the message, opened the message, and returned the questionnaire, and will accept the recommended appointment, because the messaging detail cells 910 corresponding to these column headings 905 on the detail screen are checked with an “X”. However, there is a cell that has been highlighted in bold, indicating a problem 915. The patient has indicated that he will have problems making arrangements to get to the appointment. In this case, a “yes” answer to this question has been correctly interpreted by the system as an “incorrect,” outlier response which has triggered an alert for the case manager. The system will notify the case manager that there is a an alert situation, which can then be dealt with in an appropriate manner (see Managing alerts section).

### Information Storage

Referring again to FIG. 8, during actual use of the system for disease management, typically all of the activated documentation cells remain color highlighted but unmarked until the server receives information such as, but not limited to, messaging tracking data, questionnaires responses, and documentation that information text lines have been read or unread. Messaging responses from the patients, case managers and care providers are received by the server. In addition, tracking data from the messaging process, (i.e., received messages, opened messages and the like) are also received by the server. Messaging responses and tracking data migrate into the appropriate locations in the documentation spreadsheet through preset linkages. As mentioned above, an unmarked documentation cell becomes marked indicating goal achievement when events occur, such as, but not limited to, messaging being successful, the receipt of correct questionnaire responses and documentation that information text lines have been read. This information is saved for future reference in the server, organized into the format of the documentation spreadsheet. Information regarding alerts, as discussed above, such as but not limited to messaging breakdowns, outlier answers to questionnaire questions, and unread text lines, is also stored in the server.

### Accessing Information

Referring again to FIG. 3, the clinician can highlight a patient on the list 305 and click the “Documentation spreadsheet” 335 button to access patient-specific information. A screen listing the care elements automatically opens and the clinician selects a care element. After the selection, a screen containing the element specifiers automatically opens and the clinician can select an element specifier from the list provided. A documentation spreadsheet (such as FIG. 8) specific for that care element and element specifier opens. The documentation spreadsheet is typically a read-only view, except that a field for free-text entry of comments is included. In one implementation, a clinical summary button 820 is also available so that patient-specific clinical information such as, but not limited to, medical problems, adverse drug events, and medications for a particular patient can be easily accessed for viewing.

### Management of Alerts

As discussed above, the user, acting as organizational author, assigns alert status to questionnaire question lines and information text lines, making them alert active or leaving them alert inactive, during the authoring process 565. Alerts 160 are based on documentation of goals achievement, as derived from questionnaires 165 filled out by the patient 110 and the care provider 130. They are also based on documentation of successful messaging regarding receipt of messages, opening of messages, and documentation that information messaging text lines, set to be alert-active, have actually been read. The questionnaires can be particularly useful for determining whether or not the provider or the patient are going to be able to comply with specific instructions in a treatment plan for a particular pathway. For example, a questionnaire may be is used to determine whether or not a heart attack patient is taking a particular medication correctly, as prescribed. Alternatively another phase of the pathway may call for cardiovascular exercise; if the patient has a knee injury, the patient can alert the case manager that she cannot comply with the requirements for that care element in that phase of care by responding to the questionnaire.

As the pathway progresses, patient-specific data is generated by the system real-time, as questionnaire responses and information messages pass through the system. The data is analyzed by the rules engine in the server to detect outlier events which act as triggers for alerts.

When an alert is triggered, several processes are activated. First, alert-specific data migrates to the relevant area of the documentation spreadsheets, and the documentation cell representing the messaging category and the phase of care for the alert highlights in bold 825, indicating that it has become alert-activated. Second, the corresponding messaging detail cell in the messaging detail window also highlights in bold 915, to indicate that it has become alert-activated. This alert-activated messaging detail cell resides behind the documentation cell, and is accessed by double-clicking on the alert-activated documentation cell 825, which corresponds to it. Third, the server downloads into the patient's file an alert worksheet 1000 which is linked to the patient, care element, element specifier, phase of care, messaging category, and questionnaire or information messaging text line associated with the alert. This alert worksheet resides behind the alert-activated messaging detail cell 915, and is accessed by double-clicking on the cell. Forth, when the alert is triggered, an email message is generated and sent to the case manager as notification of the event. There are two ways in which the case manager receiving the alert message can access information about the alert. First, the case manager can begin at the level of the navigation screen: by highlighting the name of the patient associated with the alert on the “Active patient” list 305 and clicking the “Documentation spreadsheet” button 335, the case manager can move through the screens, selecting choices, to reach the level and location of the alert. Second, the email message may provide a link that allows the case manager to enter the system directly at the area of the spreadsheet containing the alert by double-clicking on the linkage.

Referring again to FIG. 9, the patient has indicated that he is going to have a problem making arrangements to get to the appointment. As discussed above, the corresponding cell in the documentation spreadsheet will be color highlighted bold 825 to indicate that an alert has been generated on the system from the outlier response to the question involving the particular messaging category and phase of care which the cell represents. The user can click on this cell 825 to open the messaging detail screen 900 and the cell which represents the information text line or questionnaire text line which has been alert-activated is boldly highlighted 915. When the user clicks on the boldly highlighted messaging detail cell 915 as described above with respect to FIG. 9, the alert worksheet 1000 screen is opened for viewing more detailed information about this alert and for data entry by the case manager responding to the alert.

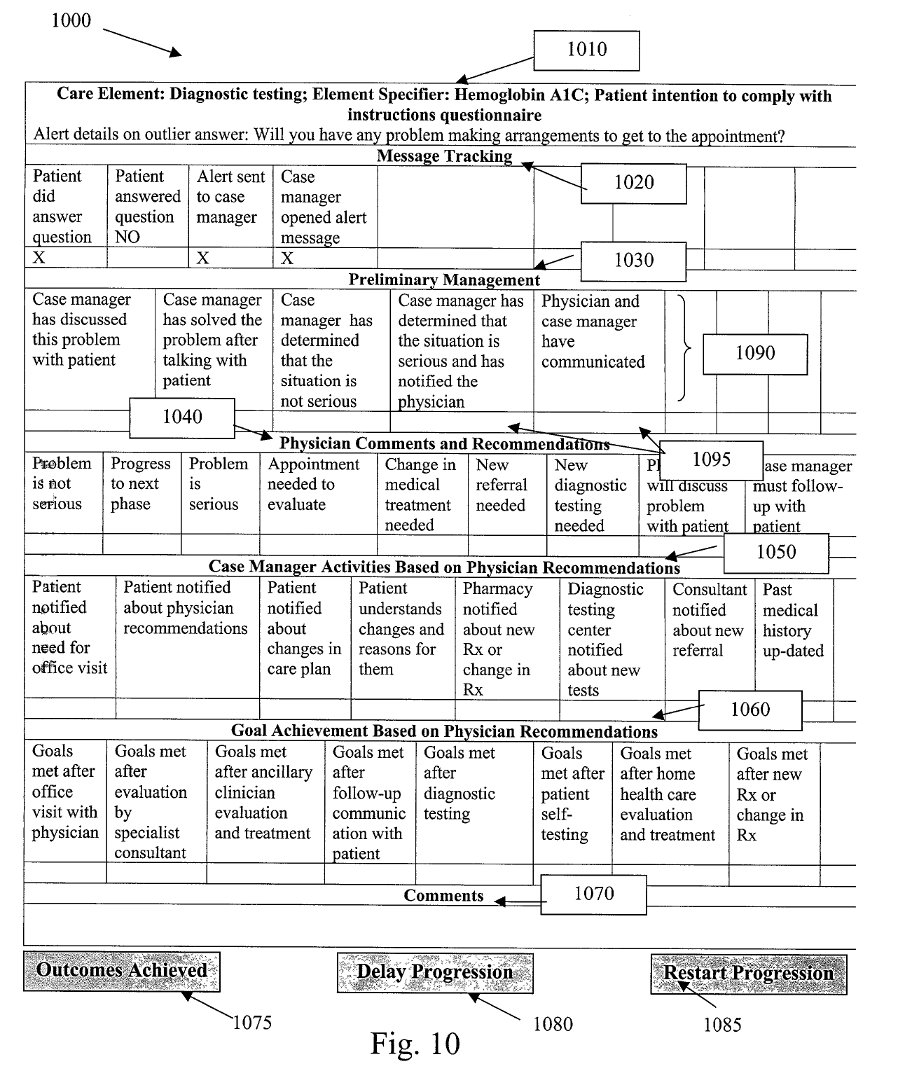

FIG. 10 illustrates an embodiment of an alert worksheet screen 1000. The alert worksheet 1000 is a table with pairs of rows divided into 6 sections for documenting activity associated with management of the alert, plus a Comment section 1070 for optional free text entry by the case manager. The sections in the alert worksheet 1000 are the Header 1010, Message Tracking 1020, Preliminary Management 1030, Physician Comments and Recommendations 1040, Case Manager Activities Based on Physician Recommendations 1050, Goal Achievement Based on Physician Recommendations 1060, and Comments 1070. A knowledge base that is carefully conceived defines the contents of the alert worksheet to optimize care delivery and data organization.

For the Preliminary Management section 1030, Physician Comments and Recommendations section 1040, Case Manager Activities Based on Physician Recommendations section 1050, and Goal Achievement Based on Physician Recommendations section 1060, the cells in the first row 1090 are headings which define the activities, recommendations, goals achievement, and conclusions regarding status, which might describe the progression and management of the alert, based on an extensive knowledge base residing in the database 135. The data entry fields (cells) 1095, which are positioned below the heading cells 1090, are marked by point and click or left unmarked, depending on the way the case manager handles the alert situation. When an alert situation occurs, the case manager role changes from passive recipient of automatically generated messages to active participant. When the case manager marks a data entry field (cell) 1095 by point and click, it indicates that the activity, recommendation, goal achievement, or conclusion regarding status named in the header 1090 above the field (cell) 1095 has occurred or is true.

The data that populates the Header (Section 1010) and Message Tracking section (Section 1020) is automatically downloaded from the server. The Header (Section 1010) displays information about the patient, care element and element specifier associated with the alert, and the questionnaire question line or information text line which triggered the alert. In the example presented in FIG. 10, the question line which triggered the alert indicates that the patient will have a problem making arrangements to get to the appointment with the dietitian. The Message Tracking section (Section 1020) displays information about the messaging process involving the alert. In the example presented in FIG. 10, the patient did answer the question with an outlier response (a “yes” answer), an alert was sent to the case manager, and the case manager did open the message. The system automatically filled in the data entry cells below the heading cells to document the success of the alert messaging process.

The Comments section (Section 1070) is a free-text entry field which gives the case manager an opportunity to describe or defend plans, activities, and conclusions regarding goal achievement.

Alerts driven activity includes, but is not limited to, communications between the case manager and patient, physician orders and instructions to the case manager in response to the alert, case manager follow-up, and documentation of goal achievement. Many situations can be resolved between the case manager and the patient, but some more serious situations may involve physician intervention. The physician can order through the case manager: an in-office visit to evaluate clinical status, a new medication or a change in the medical regimen; a new diagnostic test or follow-up testing; a referral to a specialist or other care provider; a home nurse evaluation, etc. The physician can make notations in the Comments section, if desired, and communicate permission to allow progression to the next phase (electronically through the system or verbally through the case manager.) In general, the physician provides the case manager with new instructions and advice in the management of the alert situation. It is understood by those skilled in the art of medicine that the alerts-driven activity listed above is only a small portion of the types of activities that can occur in response to an alert. Many other activities are contemplated.

### Changing Patient Progress in a Pathway

As indicated above, several situations can arise that involve changing the patient's progress in a given pathway. Several options are available to the user, who is usually the case manager but can be the physician, such as removing the patient altogether from the pathway (terminating the pathway), restarting an inactive patient on a pathway (restarting the pathway), delaying progression for one or more care elements of a pathway while allowing the remaining care elements of the pathway to progress (delaying progression), and restarting a portion of the pathway involving one or more care elements (restarting progression).

If the patient's progress through the pathway has been unsatisfactory, the case manager or physician can elect to remove the patient from the pathway. Refer to FIG. 14, Part 1. In an implementation the navigation screen contains a “Terminate pathway” button 360. When the case manager highlights the patient from the “Active patients list” view in the roster window 1405, he can click the Terminate pathway button to remove the patient from the pathway. A warning window typically opens which warns the user that further execution will result in termination of the pathway for that patient and requests that reasons for the termination be documented in the text field provided. The case manager can enter the appropriate information and execute the termination by clicking the “execute” radio button in the warning window. The patient is then automatically removed from the pathway and the patient's name migrates from the “Active patient list” view in the roster window 1405, to the “Inactive patient list” view the roster window 1410 (FIG. 14, Part 2, unless the patient is still actively progressing through another unrelated pathway. In that case, the patient remains on the active patient list, but linked only to the remaining active pathway. The patient's status bar FIG. 7 is updated to include the termination information.

An inactive patient can be restarted on a pathway. From the navigation screen FIG. 3, the case manager or physician can click the “View Patients on Inactive pathways” button 315. Refer to FIG. 14, Part 2. The “Inactive patients list” view in the roster window 1410 opens. Note that this navigation window roster view includes a unique button, the “Restart pathway” button 1425. The user can select the patient from the “Inactive patient” list by highlighting the name and clicking the “Restart pathway” button 1425. A warning window opens which warns that further execution will result in restarting the pathway for that patient. The user has the option of entering documentation regarding the reasons for restarting the pathway. To restart the pathway, the user clicks the “Execute” button in the warning window. In an implementation, when the “Execute” button is activated, the select phase screen automatically opens and the user can select the phase for restart. Subsequently, the define launch times screen opens and the user selects the re-launch time. Once the user takes these steps, the pathway restarts its progression and the patient's status bar FIG. 7 updates to reflect the change.

Another situation that may arise is that the case manager or physician wants to delay the progression for a single care element and element specifier, while allowing the rest of the pathway to progress. Refer to FIG. 10. This activity is performed using tools in the alert worksheet 1000. In this type of situation, the patient's progress is typically satisfactory for all areas of the pathway to which he has been assigned except for one care element and element specifier. This care element and element specifier can be referred to as outliers. The user views the alert worksheet for the outlier care element and element specifier. In one implementation, the alert worksheet includes a “Delay Progression” button 1080. If the Delay progression button is activated, a warning window launches that request comments regarding the reason for the progression delay and warns that further execution will result in progression delay for that care element and element specifier. If the user clicks the “Execute” radio button, progression for that care element and element specifier is delayed but all other care elements and element specifiers in that pathway continue to progress. The patient's status bar FIG. 7 is updated to indicate that progression has been delayed for the outlier care element and element specifier and to display the stop progression date.

The pathway can be restarted for a single outlier care element and element specifier, using, once again, tools in the alert worksheet 1000 (FIG. 10). This situation typically occurs when the case manager or physician determines that the issues involving the outlier care element and element specifier have been resolved. In an implementation, alert worksheet 1000 for that care element and element specifier includes a “Restart Progression” button 1085. If the “Restart progression” button is activated, a warning window launches that requests documentation regarding the reason for the progression restart and warns that further execution will result in restart of progression for the outlier care element and element specifier. If the user clicks the “Execute” radio button, progression for the outlier care element and element specifier will be restarted at the phase where progression was previously delayed. This care element and element specifier are not outliers any more; they are referred to as “reformed” outliers. The patient's status bar FIG. 7 is updated to indicate that progression has been restarted for the reformed outlier care element and element specifier and to display the restart date.

### System Administrator Duties for Data Entry

The preceding descriptions have mentioned and discussed several duties of the system administrator. The system administrator is typically also responsible for setting and defining fields for data entry as well as adding fields to data entry screens. Typically, the system administrator has different permissions than the other participants in the system. In an implementation, the navigational screen for the system administrator FIG. 3, Part 3, includes these unique buttons: the “Define data fields screen” button 365 and the “Care Providers database” button 330. The permissions for the system administrator allow him to have these additional buttons which allow him to access screens where the database is manipulated.

The system administrator can set and define fields for various databases such as but not limited to billing and demographics, the clinical summary (problems, adverse drug reactions, medications and the like), the status bar FIG. 7, the authoring bar FIG. 11, the care provider database and others.

To set the data fields, the system administrator clicks the “Define data fields” button 365 on the system administrator navigation screen FIG. 3, Part 3 to open the “Database category navigation” screen. FIG. 15 is an embodiment of a “Database category navigation” screen. It displays buttons for the following database categories: billing and demographics (for case manager entry) 1505, the clinical summary screen (for case manager entry of data regarding problems 1510, adverse drug events, 1515 and medications 1520), the status bar (for display of patient-specific pathway information) 1525, and the authoring bar (for display of authoring information) 1530. The system administrator clicks the selected button to open the “Define data fields” screen for the selected database category. FIG. 16 is an embodiment of a “Define data fields” screen (in this case, for defining Billing and Demographic data fields). It displays a table of suggested fields for data entry for selection by the system administrator. By marking the “Include” cell 1605 in the table, the data field associated with it (same row) is included in the data entry screen which will used by the case manager to fill in patient-specific information. At this point, the system administrator can also set whether or not the fields are mandatory or optional, by marking or not marking the “Make data entry mandatory” cell 1610 in the table associated with the selected data field (same row). Mandatory field settings force the user to enter data into the spaces provided because the system will not allow the user to exit the screen in which they reside until they have been filled in.

The “Define data fields” screen 1600 can also include an “Add new fields” button 1615 that launches an “Add New Field” screen (not shown). The system administrator can add the name for the new field by free text entry and add as many new fields as desired. By returning to the “Define data fields” screen 1600, the system administrator can deploy the new field by viewing the list of suggested fields that now includes the new fields he has just added to the table.

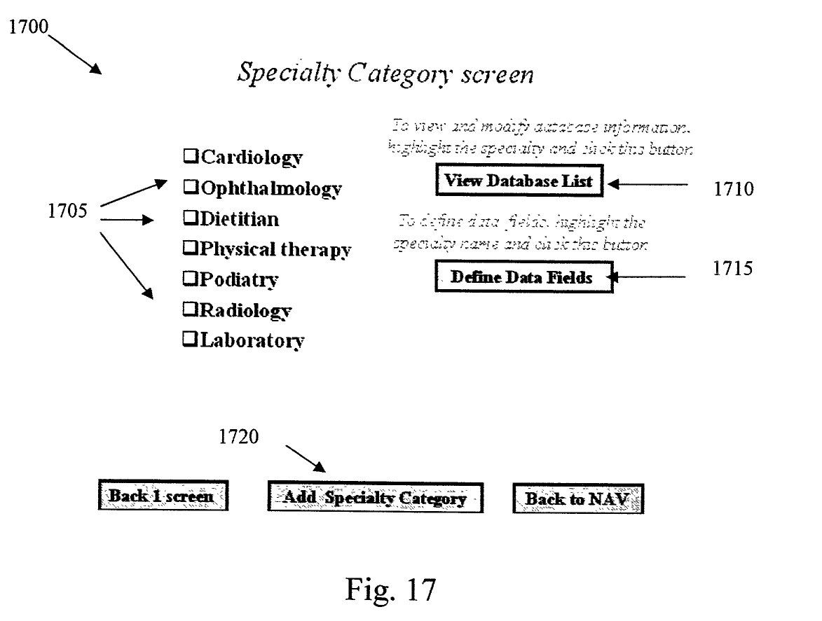

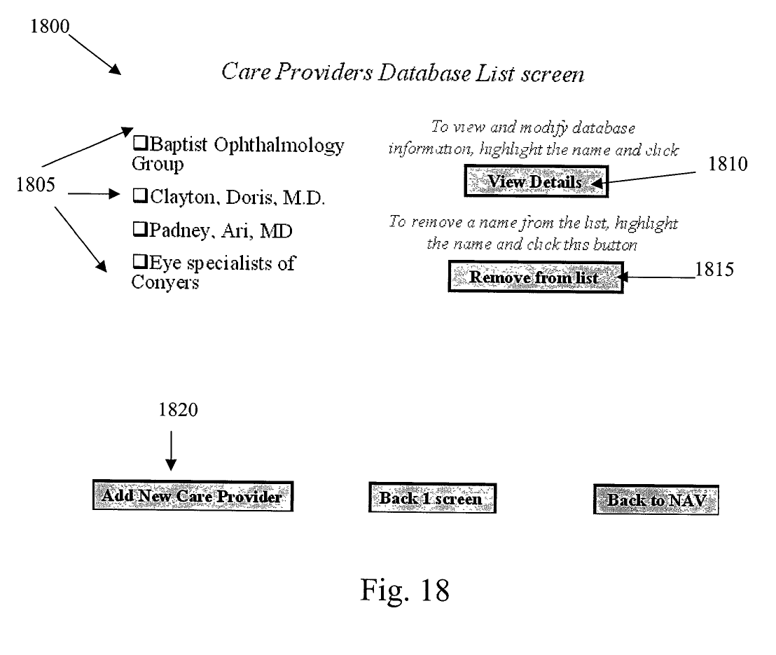

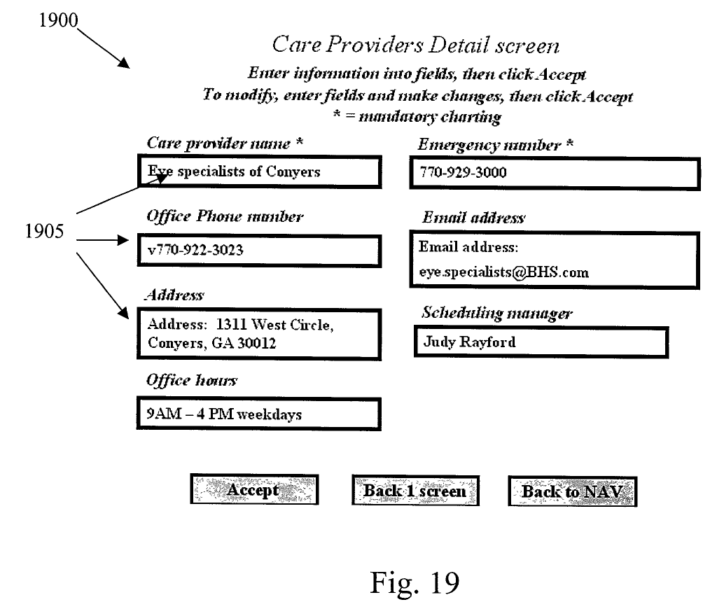

The system administrator is also responsible for managing the care providers database. This database is organized by specialty. When the system administrator clicks the “Care providers database” button 370 on the system administrator navigation screen, the “Specialty Category” screen opens. FIG. 17 is an embodiment of a “Specialty category” screen 1700. It has buttons such as, but not limited to, Ophthalmology, Cardiology, Physical therapy, Dietitian, Podiatry, Radiology, and Laboratory. The user selects a specialty category by clicking on the appropriate button 1705. Subsequently, the “Care providers database list” screen opens that is specific for the selected category. FIG. 18 is an embodiment of a “Care providers database list” screen (for this example, Ophthalmology). It allows the user to view the list of care providers in that selected specialty category, associated with the sponsoring organization, that have already been entered into the system. From this screen, the system administrator can remove a care provider from the list, by highlighting the name and clicking the “Remove from list” button 1815. To view additional billing and demographic information about the care provider, the user highlights the name and clicks the “View details” button 1810, which opens the “Care Providers detail” screen. FIG. 19 is an embodiment of a “Care Providers detail” screen. In an implementation, the fields display information about the selected care provider. The system administrator defines the fields for the “Care providers detail” screen by clicking the “Define data fields” button 1715 on the “Specialty category” screen FIG. 17, which opens a “Define data fields” screen FIG. 16, which is, in this case, for Care Provider details. Additionally, the user can enter new care providers into the system, by clicking the “Add new care provider” button 1820, on the “Care providers database list” screen FIG. 18. In an implementation, activation of this button results in the opening of a virgin “Care providers detail” screen FIG. 19. The user enters data into the fields and clicks Accept to add a new care provider to the database. The new care provider subsequently is displayed in the appropriate specialty list in the “Care Providers database list” screen FIG. 18. Finally, the user can click the “Add Specialty category” button 1720 from the “Specialty category” screen FIG. 17 to open a screen with fields for adding a new specialty category to the system. In an implementation, the new specialty category is displayed in the “Specialty category” screen FIG. 17 after the addition.

In an implementation, the system administrator has the role of assigning to a particular patient the care team: i.e., the case manager and the care providers in each specialty category who will be responsible for him or her. After assignment, the care providers and case managers receive the automatically generated instruction and goals achievement messages, in accordance with pathway progression.

### Software Techniques and Hardware

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions to, a data storage system, at least one input device, and at least one output device. Each computer program may be implemented in a high level procedural or object-oriented programming language, or in assembly or machine language, which can be compiled or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

A number of embodiments have been described. Nevertheless, is will be understood that various modifications may be made without departing from the spirit and scope of the invention. Other embodiments are within the scope of the following claims.

What is claimed is:

1. A disease management system, comprising:
an organizational author including a computer having a pathway authoring process adapted to be coupled to a network,
a case manager including a computer connected to the network,
at least one care provider including a computer connected to the network, and
at least one patient including a computer connected to the network.

2. The system as claimed in claim 1 further comprising a disease management process having a plurality of pathways, each pathway represented by phases of care.

3. The system as claimed in claim 2 wherein each of the phases of care further comprise a series of care elements, each care element adapted to be represented by one or more element specifiers.

4. The system as claimed in claim 2 wherein the disease management process further comprises disease management messages created by the organizational author, and alerts created by the organizational author and adapted to be received by the case manager and one or more of the care providers.

5. The system as claimed in claim 4 further comprising documentation spreadsheets.

6. The system as claimed in claim 1 further comprising a system administrator including a computer connected to the network and adapted to manage and process data related to the network.

7. The system as claimed in claim 1 further comprising a plurality of external databases.

8. The system as claimed in claim 1 further comprising a central knowledge base.

9. A method of managing disease, comprising:
creating a plurality of disease management pathways within a disease management system,
assigning a patient to at least one of the pathways,
creating correspondence between the patient and one or more healthcare participants, the correspondence relating to managing the patient's disease,
dynamically instructing the patient, and
tracking the patient's progress in the pathway.

10. The method as claimed in claim 9 wherein dynamically instructing the patient comprises providing the patient with healthcare information related to progress through the assigned pathway.

11. The method as claimed in claim 9 wherein tracking the patient's progress in the pathway comprises dynamically analyzing the correspondence.

12. The method as claimed in claim 11 wherein dynamically analyzing the correspondence comprises receiving patient responses relating to the progress in the pathway, detecting the existence of any problems related to the patient's progress in the pathway and addressing any detected problems.

13. A disease management process, comprising:
creating phases of care for particular disease,
associating care elements within the phases of care,
associating element specifiers for each care element,
accessing a knowledge base to cater a program related to the phases of care for the patient to follow,
dynamically instructing a patient through the phases of care,
enabling correspondence between the patient and healthcare participants,
alerting the healthcare participants when there is an alert-situation related to the patient,
addressing the alert-situation,
keeping documentation related to the patient's progress though the phases of care,
optionally modifying the phases of care if changes in the patient's progress occurs, and
removing the patient from the phases of care if the disease has been successfully managed.

14. A disease management graphical user interface, comprising:
a plurality of subject-matter graphical elements that enable a user to view disease management screens,
a roster window containing data corresponding to the subject matter of the subject-matter graphical elements, and
a plurality of navigational graphical elements that enable a user to navigate through a plurality of data screens associated with the interface.

15. The graphical user interface as claimed in claim 14 wherein the disease management screens include a documentation spreadsheet related to a patient's progress.

16. The graphical user interface as claimed in claim 14 wherein the disease management screens include a pathway authoring screen.

17. The graphical user interface as claimed in claim 14 wherein the disease management screens include a pathway assignment screen.

18. The graphical user interface as claimed in claim 14 wherein the disease management screens include a clinical summary screen.

19. The graphical user interface as claimed in claim 14 wherein the data screens include an active and inactive patient listing.

20. The graphical user interface as claimed in claim 14 wherein the data screens include a listing of available pathways.

21. The graphical user interface as claimed in claim 14 further comprising an informational bar.

22. The graphical user interface as claimed in claim 21 wherein the informational bar includes patient-specific information.

23. The graphical user interface as claimed in claim 21 wherein the informational bar includes pathway authoring information.

24. A method of authoring a disease management process, comprising:
identifying a plurality of diseases, defining phases of care associated with each the diseases,
defining care elements within each of the phases of care,
defining element specifiers associated with each of the care elements, and storing the process in a system.

25. The method as claimed in claim 24 further comprising authoring messages associated with the phases of care.

26. The method as claimed in claim 24 further comprising identifying alert situations within each of the phases, and creating additional messages associated with the alerts.

27. The method as claimed in claim 24 further comprising creating a status bar containing information relating to the process and to a specific assigned patient, and creating a documentation spreadsheet containing information related to the patient.
